(19) United States
(12) Patent Application Publication
(10) Pub. No.: US 2019/0354968 A1
(43) Pub. Date: Nov. 21, 2019

(54) Utilization Management Method, Utilization Management System, and Node

(71) Applicant: Hitachi, Ltd., Tokyo (JP)

(72) Inventors: Tatsuya SATO, Tokyo (JP); Yosuke HIMURA, Tokyo (JP)

(21) Appl. No.: 16/288,402

(22) Filed: Feb. 28, 2019

(30) Foreign Application Priority Data
May 16, 2018 (JP) 2018-094246

(51) Int. Cl. G06Q 20/38

(52) U.S. Cl. CPC G06Q 20/389; H04L 9/30; G06Q 20/3825

(57) ABSTRACT

Each of a plurality of predetermined nodes in a distributed ledger system executes a first smart contract which manages a processing history of a transaction in the distributed ledger system in a distributed ledger, executes a second smart contract which performs, with respect to a management target system commonly used by the plurality of organizations, calculation of at least any one of a consumption degree by each of the plurality of organizations of the management target system and a contribution degree by each of the plurality of organizations to the management target system based on the processing history stored in the distributed ledger, and stores a result of the calculation in the distributed ledger.

### CROSS-REFERENCE TO RELATED APPLICATIONS

The present application claims priority pursuant to 35 U.S.C. § 119 from Japanese Patent Application No. 2018-094246, filed on May 16, 2018, the entire disclosure of which is incorporated herein by reference.

### BACKGROUND

The present invention relates to a utilization management method related to a distributed ledger system, a utilization management system, and a node, and more particularly, to a technology capable of accurately understanding and utilizing a utilization situation of a system which is commonly utilized by constituent organizations of a consortium-type distributed ledger system, and a contribution situation thereto.

A technology for a distributed ledger as a direct transaction between users (peer to peer (P2P)) has emerged in lieu of a transaction through a central organization (for example, a financial institution or a government) which has been conducted conventionally.

As the technology, for example, a technology (see “A Peer-to-Peer Electronic Cash System”, [online], [searched on Mar. 31, 2017], the Internet <URL: https://bitcoin.org/bitcoin.pdf>) in which a virtual currency is used to thereby perform a settlement transaction without requiring a central organization such as a bank, has been suggested. In this technology, validity of transaction data (hereinafter, also referred to as transaction) on a P2P network is determined by a node which is called minor, and then an operation of calculating a certain hash value which is called a proof-of-work is performed for finalization. Here, finalized transactions are bundled up into one block and recorded in a distributed ledger which is called a blockchain (hereinafter, referred to as BC). It should be noted that a system constituted by nodes of participants in the distributed ledger is called a distributed ledger system.

Meanwhile, in recent years, on the basis of the BC mounted based on the above-described technology, various derivative technologies related to the BC and the distributed ledger have been suggested and have continuously evolved.

Main characteristics of the current BC include: (1) finalizing a transaction by consensus built by or approvals made by (arbitrary or certain) participants other than a central organization, in the transaction among participants on a distributed ledger system, (2) bundling a plurality of transactions up into a block, recoding blocks in a distributed ledger in a row, performing hash calculation for consecutive blocks to substantially preclude falsification, and (3) sharing the same ledger data among all participants to enable confirmation of the transaction by all participants.

Since the distributed ledger technology including the BC includes the above-described characteristics, application thereof in a wide range of fields such as a financial field or Internet of things (IoT), as a structure for management/sharing of reliable data or execution/management of a transaction based on a contract, has been considered.

For example, in order to enable the distributed ledger to be applied not only to a simple conventional transaction of a virtual currency, but also to a complicated transaction condition or various applications, logic has become manageable as well in the distributed ledger, in addition to (transaction) data. This logic is called a smart contract (hereinafter, also referred to as SC).

In this connection, a distributed ledger system (“Ethereum White Paper”, [online], [searched on Mar. 31, 2017], the Internet <URL: https://github.com/ethereum/wiki/wiki/[English]-White-Paper> and “Hyperledger Fabric”, [online], [searched on Mar. 31, 2017], the Internet <URL: http://hyperledger-fabric.readthedocs.io/en/latest/>) having a function of executing the SC described above exists. In such a distributed ledger system, a transaction (hereinafter, also referred to as TX) is accepted while building consensus between nodes at a predetermined consensus level, and each node executes the TX, thereby sharing information (ledger) among a plurality of nodes. Further, a smart contract (SC) execution function of executing logic predetermined for the TX is provided.

In particular, unlike a conventional, so-called public-type, in the consortium-type distributed ledger system constituted by nodes between certain companies/organizations, it is possible to automatically execute a transaction according to contents (the above-described SC) of a contracts which are agreed upon in advance and encoded, while respective nodes are synchronized/interworked with each other based on a distributed consensus protocol among a plurality of organizations participating a corresponding consortium.

In this case, a plurality of organizations with different administrative domains is gathered together while bringing a resource, respectively, thereby implementing the distributed ledger system. Therefore, respective organizations use resources or data together and complete a transaction, thereby sharing cross-organizational values or cross-organizational information.

Meanwhile, in order to maintain/operate such a consortium-type distributed ledger system, each organization needs to provide a resource such as a node or data thereof. Further, a charging management technology for managing costs for the provision of the resource is also required.

An example of a conventional technology related to the charging management includes, for example, a cloud-shared resource providing system (see JP 2013-69237 A) in which a plurality of user terminals, a resource provider, and a plurality of public clouds are communicably connected via a network, in each of the plurality of public clouds, a shared-use server managed by the resource provider is installed, the resource provider has a control unit and a storage unit, the control unit has a registration unit and an execution control unit, the storage unit stores data of a program of the user together with management information, the registration unit carries out processing of storing the data of the program of the user in the storage unit together with the management information based on an instruction from the user, the execution control unit carries out control processing so that the program of the user of the storage unit is executed by the target shared-use server of the target public cloud based on an instruction from the user, and based on the control from the execution control unit, processing of the program of the user is caused to operate on the target shared-use server of the target public cloud.

An example of a means for performing charging management across an entire consortium includes a method of collecting uniform charges (for example, a charge for participation) from respective organizations as (charging of) an operation and maintenance cost of the distributed ledger system, in addition to requesting the respective organizations to provide (for example, provide a node or data thereof) a resource or data.

However, balance between the burden of maintenance and operation (provision of resources or data or payment of uniform charges) and system consumption (for example, a processing of a transaction required by an organization itself, or reference or accumulation of data) is different for each organization in the consortium. For this reason, when applying the method described above, unfairness in the burden between organizations easily occurs.

In a case of an organization of which the balance described above is skewed toward the burden of maintenance and operation, the sense of unfairness is increased and motivation for providing a resource or the like becomes poor. Then, a quality or quantity of a resource or the like in the distributed ledger system is decreased, which may finally cause a system failure.

Meanwhile, in the conventional technology described above, it is assumed that a resource provider (central organization) can understand a utilization situation of a resource in all organizations and an operation situation of each cloud resource, and the conventional technology described above can be applied to a consortium-type distributed ledger system in which a plurality of resource providers exist.

That is, in the conventional technology, there is no means for accurately understanding, among respective organizations, a utilization situation of a resource or the like in each organization and a situation of a contribution to a consortium by provision of a resource or the like. Further, even when the understanding of the situations is performed by a self-report from each organization, credibility is uncertain.

### SUMMARY

An object of the present invention is to provide a technology capable of accurately understanding and utilizing a utilization situation of a system which is commonly utilized by constituent organizations of a consortium-type distributed ledger system and a contribution situation thereto.

An aspect of the present invention provides a utilization management method, wherein in a distributed ledger system constituted by respective nodes of a plurality of organizations, each of at least a predetermined plurality of nodes among the nodes executes a first smart contract which manages a processing history of a transaction in the distributed ledger system in a distributed ledger, executes a second smart contract which performs calculation of at least any one of a consumption degree by each of the plurality of organizations of a management target system commonly used by the plurality of organizations and a contribution degree by each of the plurality of organizations to the management target system based on the processing history stored in the distributed ledger, and stores a result of the calculation in the distributed ledger.

Another aspect of the present invention provides a utilization management system, including: at least a predetermined plurality of nodes among nodes in a distributed ledger system constituted by the respective nodes of a plurality of organizations, wherein each of the plurality of nodes executes a first smart contract which manages a processing history of a transaction in the distributed ledger system in a distributed ledger, executes a second smart contract which performs calculation of at least any one of a consumption degree by each of the plurality of organizations of a management target system commonly used by the plurality of organizations and a contribution degree by each of the plurality of organizations to the management target system based on the processing history stored in the distributed ledger, and stores a result of the calculation in the distributed ledger.

Still another aspect of the present invention provides a node, wherein the node is a predetermined node among nodes in a distributed ledger system constituted by the respective nodes of a plurality of organizations, executes a first smart contract which manages a processing history of a transaction in the distributed ledger system in a distributed ledger, executes a second smart contract which performs calculation of at least any one of a consumption degree by each of the plurality of organizations of a management target system commonly used by the plurality of organizations and a contribution degree by each of the plurality of organizations to the management target system based on the processing history stored in the distributed ledger, and stores a result of the calculation in the distributed ledger.

According to the present invention, it is possible to accurately understand and utilize a utilization situation and a contribution situation with respect to a system which is commonly utilized by constituent organizations of a consortium-type distributed ledger system.

### BRIEF DESCRIPTION OF DRAWINGS

FIGS. 1A and 1B are diagrams illustrating an example of a concept of a consortium-type distributed ledger system according to a first embodiment;

FIG. 2 is a diagram schematically illustrating a computer system in the consortium-type distributed ledger system according to the first embodiment;

FIG. 3 is a diagram illustrating an example of a physical configuration of a distributed ledger node according to the first embodiment;

FIGS. 4A and 4B are diagrams illustrating an example of a data structure of a blockchain on a distributed ledger according to the first embodiment;

FIGS. 5A and 5B are diagrams illustrating an example of a data structure of a blockchain on a distributed ledger according to the first embodiment;

FIG. 6 is a diagram illustrating an example of a data structure of state information on a distributed ledger according to the first embodiment;

FIG. 7 is a diagram illustrating an example of a data structure of configuration information according to the first embodiment;

FIG. 8 is a diagram illustrating a data structure and processing contents of a system consumption/contribution degree calculation smart contract (SC) according to the first embodiment;

FIGS. 9A and 9B are diagrams illustrating system consumption/contribution degree calculation logic managed as state information of the system consumption/contribution degree calculation SC according to the first embodiment;

FIGS. 10A and 10B are diagrams illustrating system consumption/contribution degree calculation logic managed as state information of the system consumption/contribution degree calculation SC according to the first embodiment;

FIG. 11 is a diagram illustrating a system consumption/contribution degree calculation result managed as state information of the system consumption/contribution degree calculation SC according to the first embodiment;

FIG. 12 is a diagram illustrating a point aggregation result managed as state information of the system consumption/contribution degree calculation SC according to the first embodiment;

FIG. 13 is a diagram illustrating a flow example 1 of a utilization management method of a distributed ledger system according to the first embodiment;

FIG. 14 is a diagram illustrating a flow example 2 of a utilization management method of a distributed ledger system according to the first embodiment;

FIG. 15 is a diagram illustrating a flow example 3 of a utilization management method of a distributed ledger system according to the first embodiment;

FIG. 16 is a diagram illustrating a flow example 4 of a utilization management method of a distributed ledger system according to the first embodiment;

FIG. 17 is a diagram schematically illustrating a computer system in a consortium-type distributed ledger system according to a third embodiment; and

FIG. 18 is a diagram illustrating a flow example of a utilization management method of a distributed ledger system according to the third embodiment.

### DETAILED DESCRIPTION OF THE EMBODIMENTS

### First Embodiment

### Concept of Consortium-Type Distributed Ledger System

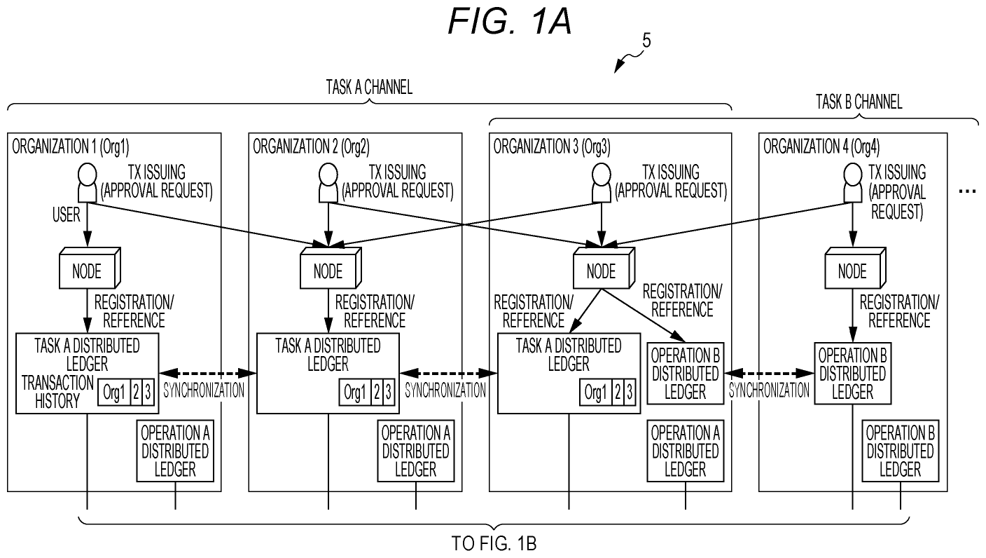

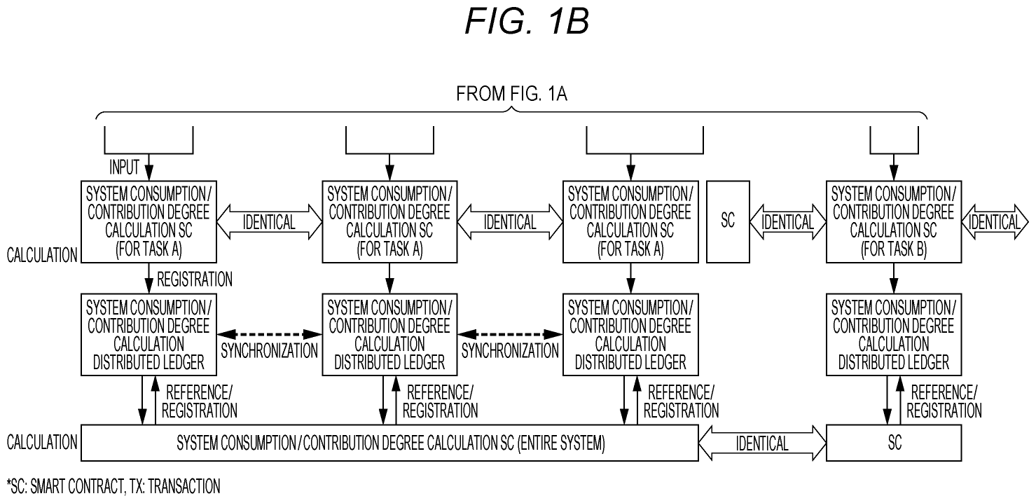

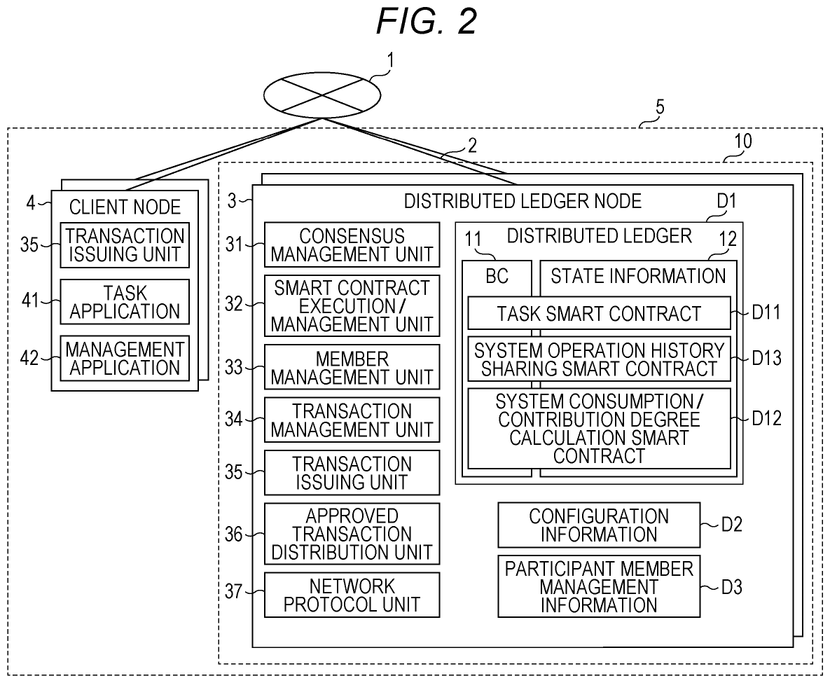

First, a basic concept of a consortium-type distributed ledger system will be described. FIGS. 1A and 1B illustrate an example of a concept of a consortium-type distributed ledger system 5 according to a first embodiment. Further, FIG. 2 illustrates an example of a configuration of a computer system of the consortium-type distributed ledger system 5.

The consortium-type distributed ledger system 5 (hereinafter, referred to as a distributed ledger system 5) according to the present embodiment is configured to include a utilization management system 10 capable of accurately understanding and utilizing a utilization situation of a system (at least any one of the distributed ledger system 5 itself or another management target system) which is commonly utilized by constituent organizations of a corresponding consortium, and a contribution situation thereto.

The utilization management system 10 is a system constituted by distributed ledger nodes 3 (FIG. 2) in the distributed ledger system 5.

In addition, here, the system which is a management target of the utilization management system 10, that is, the management target system is the distributed ledger system 5 itself, but the present invention is not limited thereto as described below.

Each distributed ledger node 3 constituting the utilization management system 10 manages at least a task smart contract D11 (corresponding to a first smart contract, similarly to a system operation history sharing smart contract D13 to be described below) which processes a transaction corresponding to a task processing performed by an organization to which the distributed ledger node 3 belongs, and stores execution history in a distributed ledger D1, the system operation history sharing smart contract D13 (hereinafter, referred to as a system operation history sharing SC, the first smart contract) which stores information of the transaction processed as described above in the distributed ledger D1 as an operation history after consensus building, and a system consumption/contribution degree calculation smart contract (hereinafter, referred to as a system consumption/contribution degree calculation SC, a second smart contract) which calculates a consumption degree of the distributed ledger system 5 or a contribution degree to the corresponding system based on the execution history or the operation history (these correspond to a “processing history” in the present invention) described above in the distributed ledger D1.

The system consumption/contribution degree calculation SC is a smart contract which states a calculation method (calculation policy) related to a consumption degree of a system (a value obtained by quantifying a utilization situation of a corresponding system) and a contribution degree to the corresponding distributed ledger system 5 (a value obtained by quantifying a provision situation of a resource, data, or a service to the corresponding system) of each participant organization of the distributed ledger system 5 as the management target system.

In the configuration illustrated in FIGS. 1A and 1B, when an execution TX of the system consumption/contribution degree SC is issued to the nodes (hereinafter, referred to as the distributed ledger nodes 3) constituting the distributed ledger system 5 described above as a calculation processing execution request, a consensus building processing for the execution TX is performed among the distributed ledger nodes 3. In addition, after the consensus building is performed, a consumption degree or a contribution degree by each participant organization is calculated on each distributed ledger node 3 according to a calculation policy defined in the system consumption/contribution degree calculation SC. In the system consumption/contribution degree calculation SC, a calculation method for calculation logic of reward/remuneration for the consumption degree or the contribution degree, and aggregation/distribution of the reward/remuneration is described as a policy or a calculation method. The distributed ledger node 3 uses such an SC function, and since the same calculation processing is performed on each distributed ledger node 3, it is possible to substantially perform the calculation processing while mutually confirming calculation results.

On such a background, the participant organization of the distributed ledger system 5 according to the present embodiment defines a cross-organizational system consumption/contribution degree calculation SC (for each task) and arranges the system consumption/contribution degree SC on a distributed ledger of the distributed ledger node 3. A calculation policy in the system consumption/contribution degree SC includes calculation logic, attributes of the execution history or the operation history as an input of the calculation, and the like.

It should be noted that the calculation logic establishes a calculation formula of the reward/remuneration (and the aggregation/distribution among organizations) for the consumption degree of the distributed ledger system 5 or the contribution degree to the distributed ledger system 5.

In addition, as the input of the calculation logic, achievement information (in detail, it is the execution history or the operation history accumulated in the distributed ledger, and corresponds to the processing history) mutually managed by a plurality of organizations or information of the participant organizations in the distributed ledger system 5 is used.

The distributed ledger node 3 executes the system consumption/contribution degree SC, calculates a consumption degree or a contribution degree by each organization while performing consensus building/verification mutually with another distributed ledger node 3 based on the corresponding SC, and stores a result of the calculation in a distributed ledger of the distributed ledger node 3 itself.

In addition, the distributed ledger node 3 stores a result of aggregating/distributing the calculation result of the consumption degree or the contribution degree for each organization in the distributed ledger while performing consensus building/verification mutually with another distributed ledger node 3 based on the system consumption/contribution degree SC. It should be noted that when a plurality of tasks with different utilization organizations exist, calculation of all consumption degrees or contribution degrees is performed in a cross-task manner (similarly according to the smart contract).

In FIGS. 1A and 1B, there are two tasks including a task A and a task B, and utilization groups thereof are different from each other (in the drawing, the different task groups are referred to as a channel).

For example, in a task A channel, at least an organization 1 (Org1), an organization 2 (Org2), and an organization 3 (Org3) participate, and nodes are owned/mutually utilized among the respective organizations. For example, in an example in the drawing, when the Org1 issues a transaction (hereinafter, referred to as TX), execution/approval of the corresponding TX is performed not only by a node of the Org1 itself, but also by a node of another organization (Org2). In addition, a TX execution result is copied to be shared in a distributed ledger of each organization.

For example, a copy of the TX execution result or execution history of the task A, which is synchronized among distributed ledgers of the Org1, the Org2, and the Org3 are held. The distributed ledgers mutually hold transaction information given consent/approval according to a level agreed upon by the participant organizations. By doing so, data held in the distributed ledger are data with high falsification resistance or high objectivity.

Meanwhile, the data held in the distributed ledgers are skewed according to a TX issuing amount of an organization or the like. For example, in this drawing, a case where an amount of data of the Org1 is larger than that of the Org2 or Org3 is illustrated.

As described above, when a node processing amount and an amount of data accumulated in the distributed ledger are different for each organization according to the TX issuing amount or the like, an operation history or an execution history accumulated in the distributed ledger is used as achievement information, and a calculation policy of a cross-organizational consumption degree or a cross-organizational contribution degree (hereinafter, referred to as a system consumption/contribution degree) is made into an SC and a plurality of organizations perform mutual calculation, thereby implementing understanding and calculation of an impartial/fair system consumption situation and a system contribution situation among a plurality of organizations constituting a consortium.

Here, when an operation work history of the distributed ledger system 5 related to the task, or the like is shared as a history accumulated in the distributed ledger, in addition to a TX execution history related to the task, it is possible to calculate a system consumption/contribution degree by each organization related not only to the task itself, but also to a system operation work. A calculation result is registered in the distributed ledger through the SC, and as illustrated in a lower portion of the drawing, a system consumption/contribution degree calculation SC is executed across task channels with different participant organizations, such that it is also possible to impartially/fairly perform calculation of the system consumption/contribution degree in a cross-task manner.

It should be noted that the computer system constituting the distributed ledger system 5 described above is configured to include a one or more distributed ledger nodes 3 and one or more client nodes 4 as illustrated in FIG. 2. These devices are connected to a network 1 through a physical communication line 2.

The distributed ledger node 3 is configured to include a consensus management unit 31, a smart contract execution/management unit 32 (hereinafter, also referred to as an SC execution/management unit 32), a member management unit 33, a transaction management unit 34, a transaction issuing unit 35, an approved transaction distribution unit 36, a network protocol unit 37, the distributed ledger D1, configuration information D2, and participant member management information D3.

The distributed ledger node 3 receives a TX by a function of the transaction management unit 34, performs consensus building on whether to accept the corresponding TX with another distributed ledger node 3 by a function of the consensus management unit 31, and when the consensus is built, and the distributed ledger node 3 deploys an SC and executes the deployed SC through a function of the SC execution/management unit 32.

In addition, after the execution of the SC, the distributed ledger node 3 records an execution history of the TX and an execution result in the distributed ledger D1. Here, the consensus building or the SC execution described above need not necessarily be performed by all nodes, but may be performed among some nodes and a result thereof may be distributed to another node (agreement thereon also depends on a consensus building algorithm).

In addition, the distributed ledger node 3 distributes the result (in detail, the execution history and the execution result of the TX) to a node which does not participate in the consensus building or the SC execution described above by a function of the approved transaction distribution unit 36.

Here, communication among the distributed ledger nodes 3 corresponding to the consensus building or the distribution of the approved TX among the nodes is performed by a function of the network protocol unit 37.

In addition, the distributed ledger node 3 receives a TX by the function of the transaction management unit 34 in response to a request from each node such as the client node 4 or the like, or acquires information such as an execution history of the corresponding TX or the like and allows the acquired information to be read in the client node 4 through a predetermined interface. In the present embodiment, the distributed ledger node 3 can issue a TX, and can issue various TXs through the transaction issuing unit 35.

In addition, the member management unit 33 of the distributed ledger node 3 provides a function of newly registering or authenticating a member participating in the distributed ledger system 5. In the member management unit 33, it is assumed that authentication of a participant organization and a member belonging to the organization, signing a TX, a control of SC execution authority, or the like is performed by using a secret key and a public key in pairs. Key information handled by the member management unit 33 described above is stored and managed in the participant member management information D3.

In addition, when receiving a TX, the transaction management unit 34 appropriately confirms whether an issuer of the corresponding TX is a rightful participant with authority through a function of the member management unit 33. However, this function corresponds to a publicly known technology, and a description thereof will thus be omitted.

In the configuration information D2, information of the organization constituting the distributed ledger system 5 and a member (including a node, a manager, a user, or the like) belonging to the organization is stored and managed. In the present embodiment, it is assumed that this information is managed by a function (for example, the member management unit 33 or the network protocol unit 37) of the distributed ledger node 3 and mutually held by respective nodes.

Further, in the distributed ledger D1, as already described above, ledger information is stored and managed, the ledger information being involved in an SC (hereinafter, referred to as task SC_D11) related to a task, an SC (hereinafter, referred to as system consumption/contribution degree calculation SC_D12) related to system consumption/contribution degree calculation, and an SC (hereinafter, referred to as system operation history sharing SC_D13) for sharing a system operation history.

As a data structure thereof, in the present embodiment, it is assumed that a history of a TX is BC, and state information based on an execution result of the TX is held in a table. It is assumed that values are held as a set of Key-Value in the internal table.

Meanwhile, the client node 4 is configured to include at least a transaction issuing unit 35, a task application 41, and a management application 42.

A user or a provider of an SC issues various TXs and transmits the TXs to the distributed ledger node 3 through the transaction issuing unit 35 of the client node 4. Issuer information is assigned to such a TX, and as the issuer information, authentication information (secret key) issued by a predetermined algorithm based on the participant member management information D3 is used.

In addition, the task application 41 is an application executing/managing a task processing by issuing a TX related to the task SC_D1 through the transaction issuing unit 35 described above.

In addition, the management application 42 is an application for registering/managing a system operation work history by issuing a TX related to the system operation history sharing SC_D13 through the transaction issuing unit 35, and calculating a system consumption/contribution degree by each organization by issuing a TX related to the system consumption/contribution degree calculation SC_D12 and performing a charging management based on a result of the calculation.

In the present embodiment, it is assumed that a plurality of distributed ledger nodes 3 is present, and these are managed by a plurality of subjects (for example, a plurality of operators/a plurality of organizations/a plurality of vendors).

Similarly, it is assumed that a plurality of client nodes 4 are present, and a different client node 4 is used by each of a plurality of SC users.

As for the client node 4, the authentication information assigned to the TX is changed for each user, thereby enabling sharing among a plurality of SC users.

### Hardware Configuration of Distributed Ledger Node

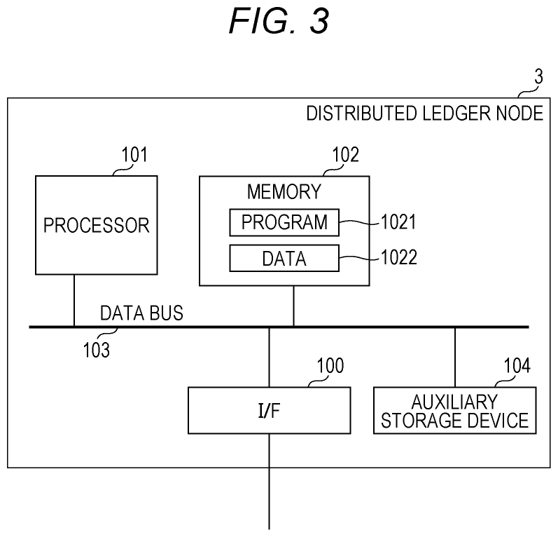

FIG. 3 is a block diagram illustrating an example of a physical configuration of the distributed ledger node 3 according to the first embodiment. The distributed ledger node 3 according to the present embodiment is a calculator including an interface (I/F) 100, a processor 101, a memory 102, and an auxiliary storage device 104.

In addition, the I/F 100, the processor 101, the memory 102, and the auxiliary storage device 104 are connected to one another by a data bus 103.

Among these, the I/F 100 can be assumed to be a network interface card communicating with another distributed ledger node 3 or the client node 4 through the network 1, or the like.

In addition, the processor 101 is an operation device such as a central processing unit (CPU), or the like.

Further, the memory 102 is a storage device for temporarily holding a program 1021 and data 1022. Specifically, the memory 102 is configured by a volatile storage means such as a random access memory (RAM).

In addition, the auxiliary storage device 104 is a storage device for storing the program 1021 or the data 1022. Specifically, the auxiliary storage device 104 is configured by a non-volatile storage means such as a solid state drive (SSD) or a hard disk drive (HDD).

The processor 101 described above reads and executes the program 1021 or the data 1022 from the auxiliary storage device 104 to the memory 102 through the data bus 103, thereby implementing a necessary function as the distributed ledger node 3.

### About Distributed Ledger

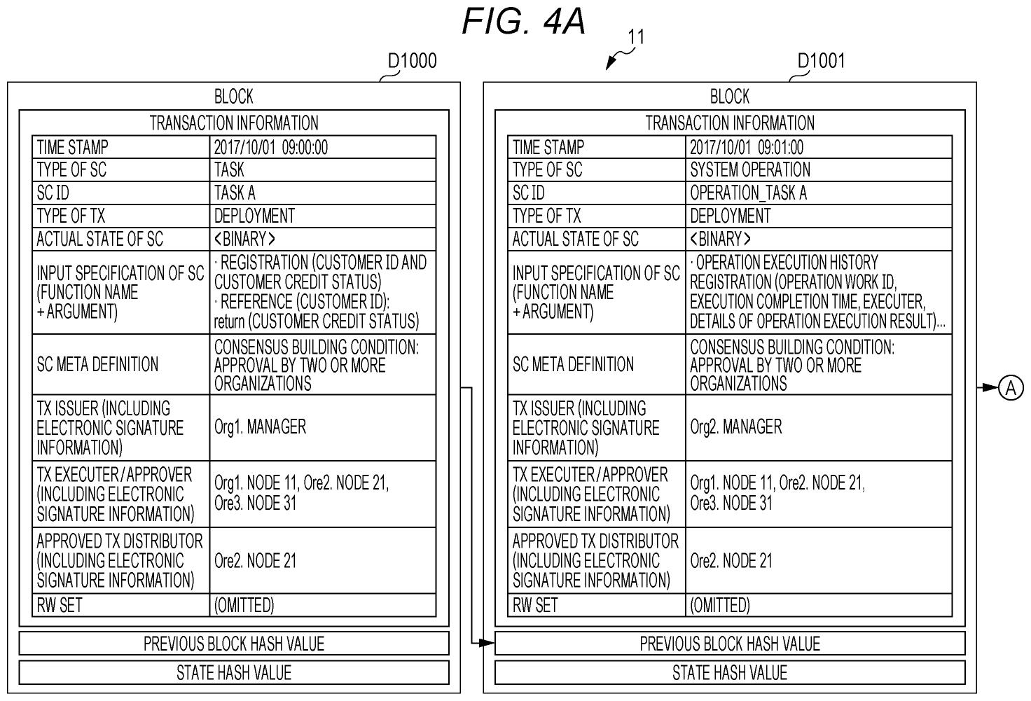

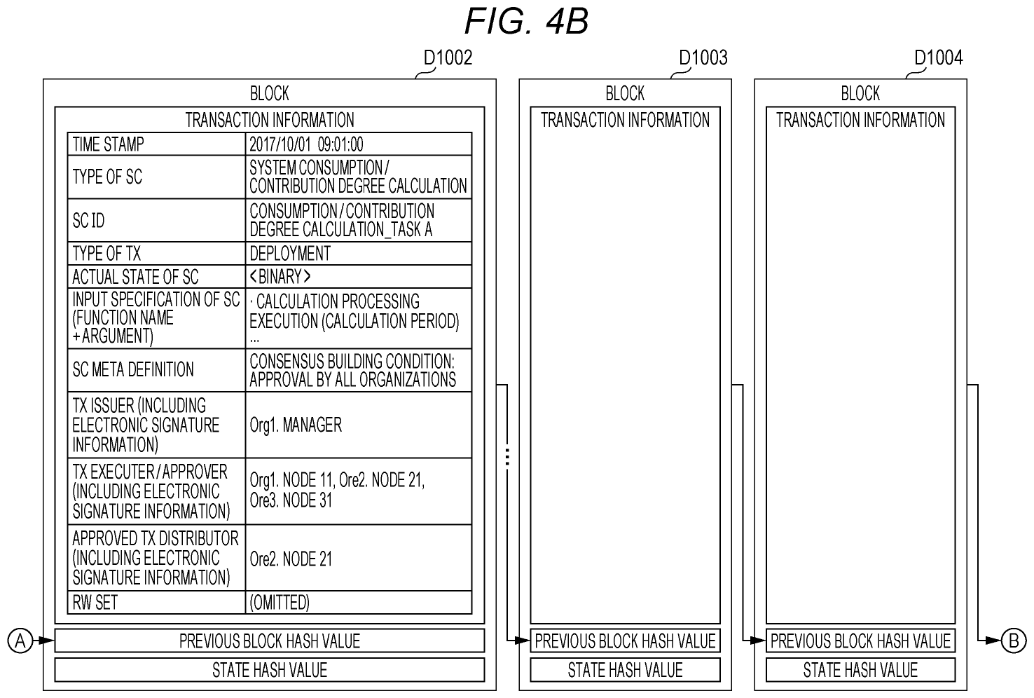

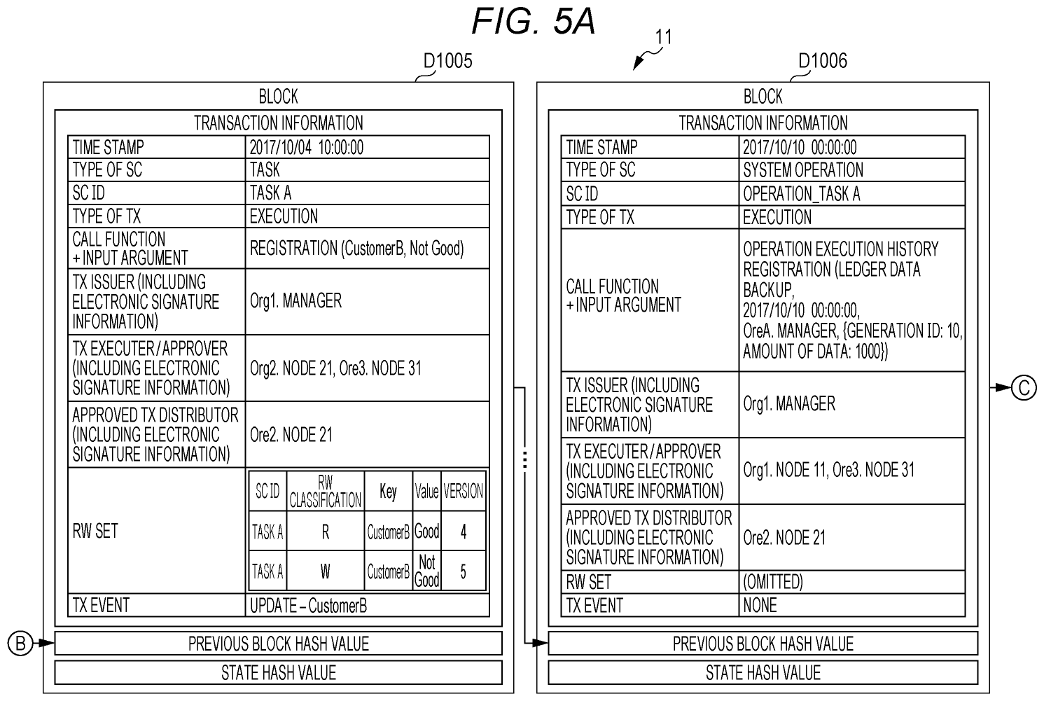

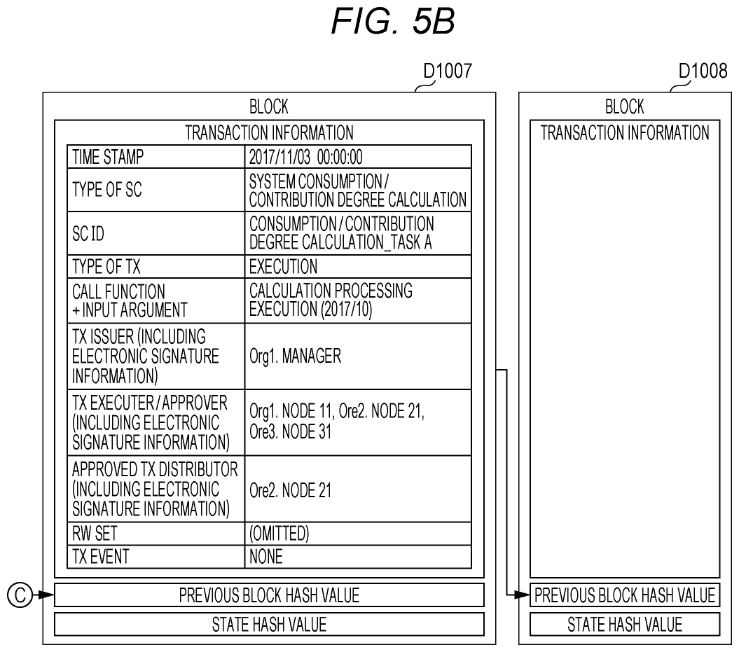

FIGS. 4A and 4B and 5A and 5B are diagrams illustrating an example of a data structure in the distributed ledger D1. FIGS. 4A and 4B illustrate an example of a blockchain (BC) 11 which is one of data structures managed on the distributed ledger D1. In distributed ledger management using the BC 11, a plurality of TXs are bundled up into a block and each block has a hash value of a previous block, thereby managing data in a row.

When a value of a block in a previous stage is changed by even one bit, hash values of all the following blocks are changed. Therefore, it is possible to make falsification difficult.

In the present embodiment, for simplification of description, a case where one TX is stored in one block is described. However, the present invention can also be applied to a case where a plurality of TXs is bundled up into one block. In addition, in the present embodiment, respective SCs (D11 to D13) are lined up with each other as a single BC. However, if the participant organizations can individually perform management/reference, the BC itself may be different.

Blocks D1000 to D1008 in FIGS. 4A and 4B and FIGS. 5A and 5B are a series of blocks constituting the BC 11. Each block includes TX information of any one of deployment and execution of a task SC, deployment and execution of a system operation history sharing SC, and deployment and execution of a system consumption/contribution degree calculation SC.

In addition, each block includes a hash value of a previous block, and includes a hash value generated from state information to be described later.

By the data structure described above, a TX history of deployment and execution of a task SC, deployment and execution of a system operation history sharing SC, and deployment and execution of a system consumption/contribution degree calculation SC is managed as a chain of data in the BC 11.

It should be noted that the block D1000 is an example of a block in which a deployment TX of a task SC is stored. In this example, an example of a business contract related to customer confirmation (Know Your Customer task) among a plurality of organizations is shown. Customer credit information on whether or not a customer is a good customer who is reliable is shared on a ledger among a plurality of organizations, such that it is possible to efficiently identify or determine the customer.

The deployment TX of the present embodiment includes a time stamp at which the TX is issued, a type of SC which specifies whether an applied SC is task or system operation or system consumption/contribution degree calculation, SC_ID which uniquely identifies the SC, a type of TX which specifies whether the TX is deployment or execution or reference, and an actual state of SC (for example, executable binary).

In addition, the deployment TX includes an SC input specification for a user to grasp a function name of the SC or an argument thereof. Further, the deployment TX includes SC meta definition which is a parameter determined according to an input argument designated at the time of deployment. As the SC meta definition, for example, a consensus building condition (for example, the TX is accepted with approval by two or more organizations) in execution of the SC, various definition information, or the like is assumed.

In addition, the deployment TX includes information of an issuer of the corresponding TX. The information of the TX issuer includes a member ID of the issuer, an issuing source, and electronic signature information used for verifying that data are not falsified. The electronic signature is generated by using a secret key of each participant member (that is, an SC provider or user) which is issued by the member management unit 33, and can be verified by a public key provided with the secret key in pairs.

Further, the deployment TX includes information (in other words, information of a participant involved in a consensus building and SC execution processing using the consensus management unit 31 and the SC management/execution unit 32) of a TX executer/approver, or information (in other words, information of a participant involved in a distribution processing by the approved TX distribution unit 36) of an approved TX distributor, similarly to the information of the TX issuer.

Further, the deployment TX also includes information of a read-write (RW) set which is state information referred to by/updated with the corresponding TX. The RW set will be described in detail together with an execution TX to be described later.

Hereinafter, the function of the SC will also be referred to as an SC function. For example, an SC deployed in the block D1000 is provided by a “manager” of an organization “Org1” as SC_ID “task A” and the following SC functions are defined.
Function name: registration ( ), input argument: customer ID, customer credit status, return value: none
Function name: reference ( ), input argument: customer ID, return value: customer credit status

In addition, the block D1005 is an example of a block in which an execution TX of a task SC is stored. An execution TX according to the present embodiment basically has the same configuration as that of the deployment TX, but does not have the actual state of the SC or the SC input specification. Instead, information of a call SC function name and an input argument is included.

In the present embodiment, in a case of TX execution including update of a ledger, the type of TX is specified as “execution”, and in a case of a reference processing in which update of a ledger is not performed, the type of TX is designated as “reference”.

In addition, in the TX of the block D1005, an example of performing an execution request in which the SC_ID is designated as “task A”, and an input argument “CustomerB, Not Good” is specified for the SC function “registration ( )” is shown. That is, an example of calling the SC shown in the block D1000 is shown.

Further, the RW set shows state information referred to/updated at the time of the deployment or execution of (the function of) the SC and includes SC_ID, “RW classification” identifying reference (Read) or update (Write), and information of Key and Value of a target state information.

In addition, the RW set shows information of an update version number of the Value. The version number is managed for each Key of the SC_ID and increased by 1 in each update. The example of the block D1005 shows that Key “CustomerB” is referred to acquire Value “Good” of the version number “4” (first row) and Value is updated with Value “Not Good”, and as a result, the version number is updated with “5”, during the execution processing of the call of the function “registration (CustomerB, Not Good)”.

As described above, the execution result of the TX is managed/held as the RW set, such that it is possible to grasp the execution result without executing the SC. As a result, it is possible to share an SC execution result even with a node which does not execute the SC, which results in an efficient processing.

Among the blocks described above, the blocks D1001 and D1006 are examples of a block in which a deployment TX and an execution TX of the system operation history sharing SC are stored. The deployment TX and the execution TX of the system operation history sharing SC include the same information as that of the same TXs of the task SC in terms of a rough data structure. It is assumed that there is only a difference that an SC related to a task is simply described or an SC related to execution history sharing of a system operation work for the distributed ledger system 5 is described.

Here, the operation work of the distributed ledger system 5 is, specifically, for example, a backup work of a distributed ledger accumulated in a node, a patching work for a node, or the like.

The examples of the blocks D1001 and D1006 show that the SC is for a history of an operation work for the task SC (SC_ID: task A) to be registered. When a manager of each organization executes an operation work which should be shared by all organizations, information such as an operation work ID, an execution completion time, an executer, details of operation execution result, or the like is registered by the execution TX of this SC as registration of an operation execution history.

Meanwhile, the blocks D1002 and D1007 are examples of a block in which a deployment TX and an execution TX of the system consumption/contribution degree calculation SC are stored. The deployment TX and the execution TX of the system consumption/contribution degree calculation SC include the same information as that of the same TXs of the task SC in terms of a rough data structure. It is assumed that there is only a difference that an SC related to a task is simply described or an SC related to system consumption/contribution degree calculation of the distributed ledger system 5 is described.

As a result, it is possible to implement the present invention as an external function without fiddling internal functions (in detail, respective functions of 31 to 37 of the distributed ledger node 3) of the distributed ledger system 5. Details of the system consumption/contribution degree calculation SC will be described later, thus will be omitted here.

### About State Information

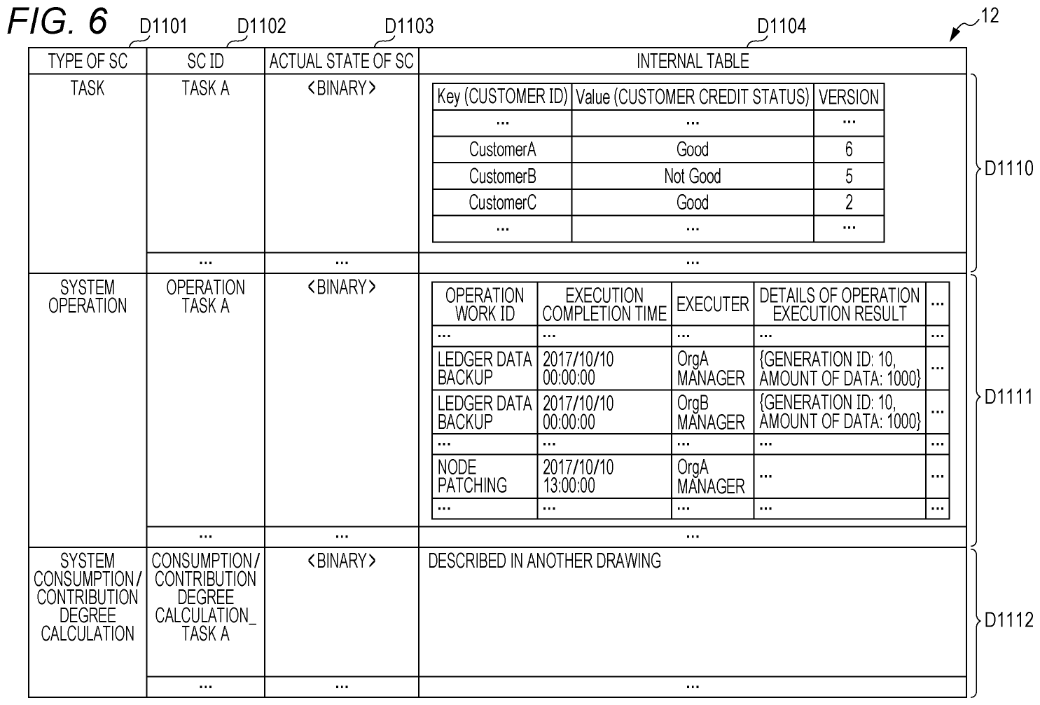

FIG. 6 illustrates state information 12 managed on the distributed ledger D1. In the distributed ledger management using the BC 11 described above, in general, in order to acquire a (latest) state (for example, a balance of an account in a case of a virtual currency), the BC 11 should be traced. In this case, however, a processing efficiency is poor. Therefore, there is a method of caching the latest state information, separately from the BC 11 (“Hyperledger Fabric”, [online], [searched on Mar. 31, 2017], Internet <URL: http://hyperledger-fabric.readthedocs.io/en/latest/>) or the like).

Also in the distributed ledger node 3 of the present embodiment, it is assumed that the latest state information 12 is held. In the present embodiment, a data region of a state is prepared for each SC.

The state information 12 holds SC_ID and an actual state of the SC. Therefore, the SC execution/management unit 32 can acquire the actual state of the SC with the SC_ID as a key and can execute the SC. In addition, the state information 12 includes an internal table for holding an execution result of the SC. The distributed ledger node 3 updates contents of the internal table for each TX execution. Also in this state information 12, information of each of a task SC, a system operation history sharing SC, a system consumption/contribution degree calculation SC, and the like are stored.

Here, an internal table of information D1110 related to the task SC in the state information 12 is associated with the RW set described above with reference to FIGS. 4A and 4B, and the up-to-date state reflecting all the RW sets is held. In a typical implementation example, data are held in such a form of Key-Value, data structured in a form of JavaScript (registered trademark) Object Notation (JSON) can also be stored in Value. In this case, a table with an arbitrary data schema can be held. In addition, by devising a design of Key, a plurality of tables (information with different schema) can be virtually managed in the internal table. In a case of an internal table of information D1111 related to the system operation history sharing SC or information D1112 related to the system consumption/contribution degree calculation SC, for simplification of description, structured data are stored in Value, and description of Key-Value-version or the like is omitted. For example, in the case of the information D1111, in practice, information of an operation work ID, an execution completion time, an executer, and details of operation execution result is stored in the Value in a JSON form or the like.

In addition, the distributed ledger system 5 can also provide a function of issuing an event with addition of a TX to a distributed ledger, and notifying a node of each participant organization. The node of each participant organization can behave according to such an event. A TX event included in the TX information of FIG. 5A and 5B is event information issued when using such an event management function of the distributed ledger.

### Configuration Information

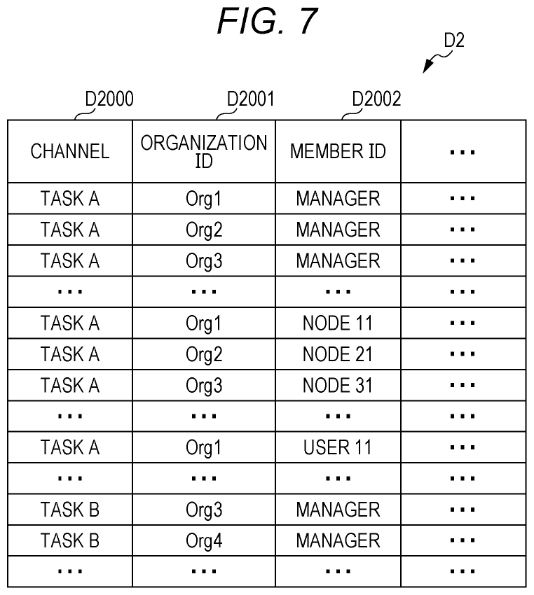

FIG. 7 is a diagram illustrating an example of a data structure of the configuration information D2. In the configuration information D2 according to the present embodiment, information of the organization constituting the distributed ledger system 5 and the member (including a node, a manager, a user, or the like) belonging to the organization is stored.

A channel D2000 in the configuration information D2 indicates a task performed in the distributed ledger system 5. In addition, organization ID_D2001 indicates an organization participating in the distributed ledger system 5 (and a channel). Further, member ID_D2002 is information for identifying a member in a participant organization. In detail, the member ID_D2002 is information for identifying a manager, a node, and a user.

In the example of the configuration information, a task A and a task B exist as the channel, and a state of a network in which at least organizations “Org1”, “Org2”, and “Org3” participate in the task A, and in which at least organizations “Org3” and “Org4” participate in the task B is shown.

The organization need not necessarily have the distributed ledger node 3 and there also are cases of only using a system through the client node 4.

### System Consumption/Contribution Degree Calculation SC

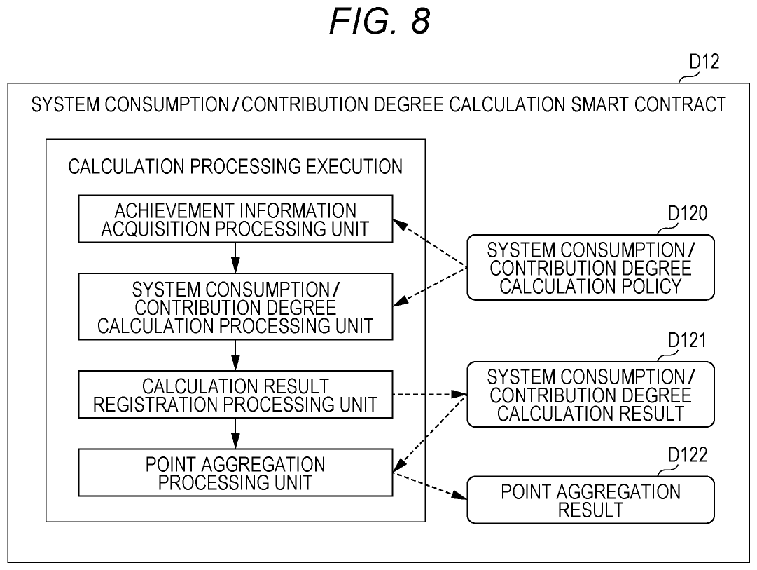

FIG. 8 is a diagram illustrating an example of a data structure and an SC function of a system consumption/contribution degree calculation SC according to the present embodiment. It should be noted that the data structure of the system consumption/contribution degree calculation SC is managed and held as the state information 12.

In the data structure in the system consumption/contribution degree calculation SC, a “system consumption/contribution degree calculation policy D120” is described as a policy related to the system consumption/contribution degree calculation.

In addition, a “system consumption/contribution degree calculation result D121” as a calculation result thereof, and a “point aggregation result D122” as an aggregation result based on the above result are managed. Details of a data structure of each of the system consumption/contribution degree calculation result D121 and the point aggregation result D122 will be described later.

Here, as the SC function, at least “calculation processing execution” for calculating the system consumption/contribution degree in a designated period is defined. The SC function may also be an SC function for changing a definition of the system consumption/contribution degree calculation policy or an SC function for acquiring/referring to a definition or various calculation results, which is, however, omitted from the drawing. A detailed flow of the SC function “calculation processing execution” described above will be described later by using a flowchart.

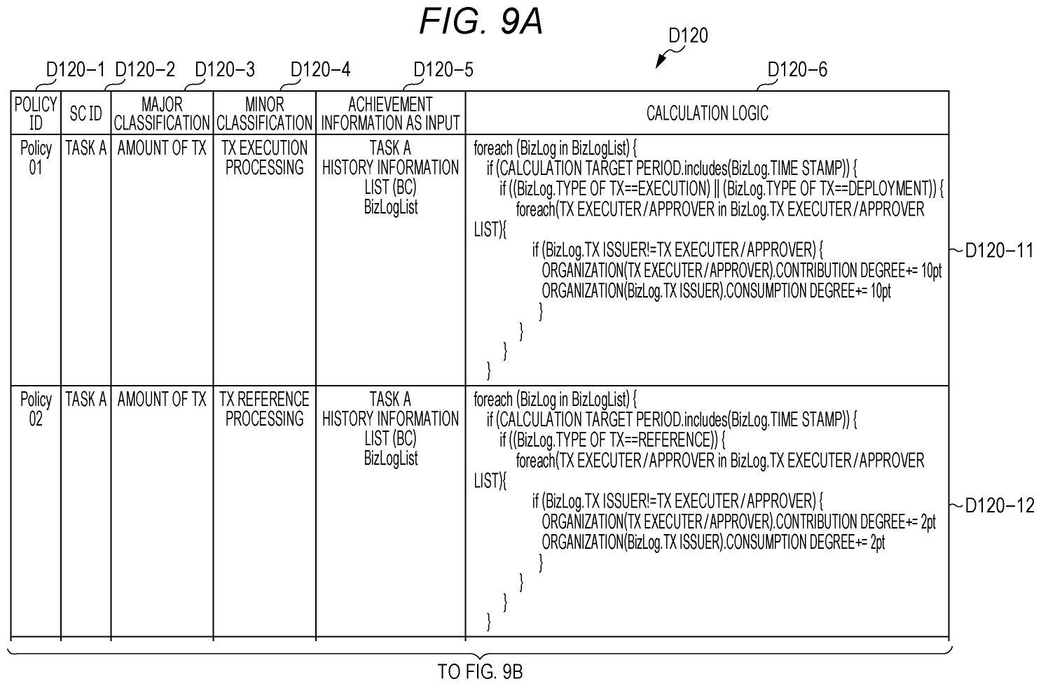

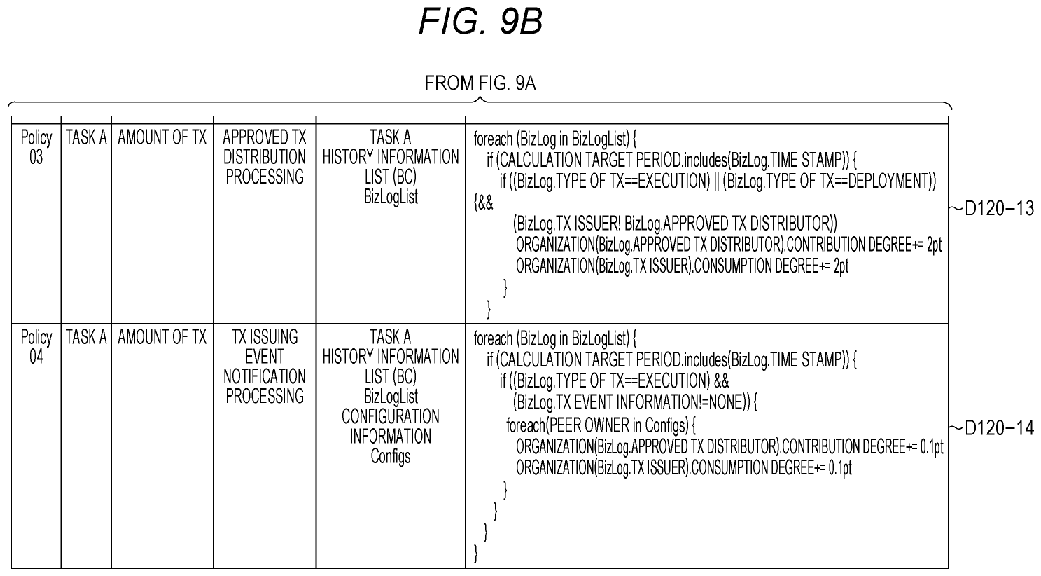

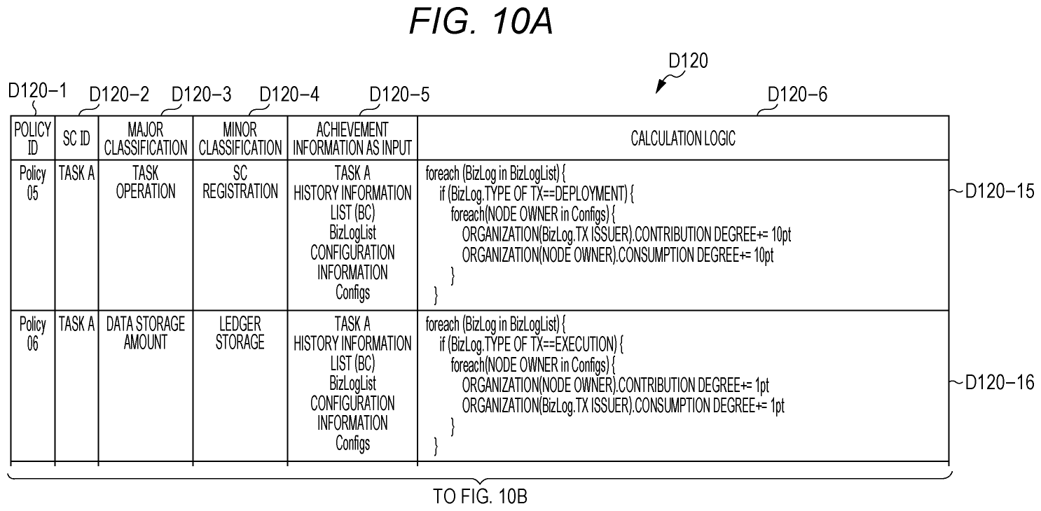

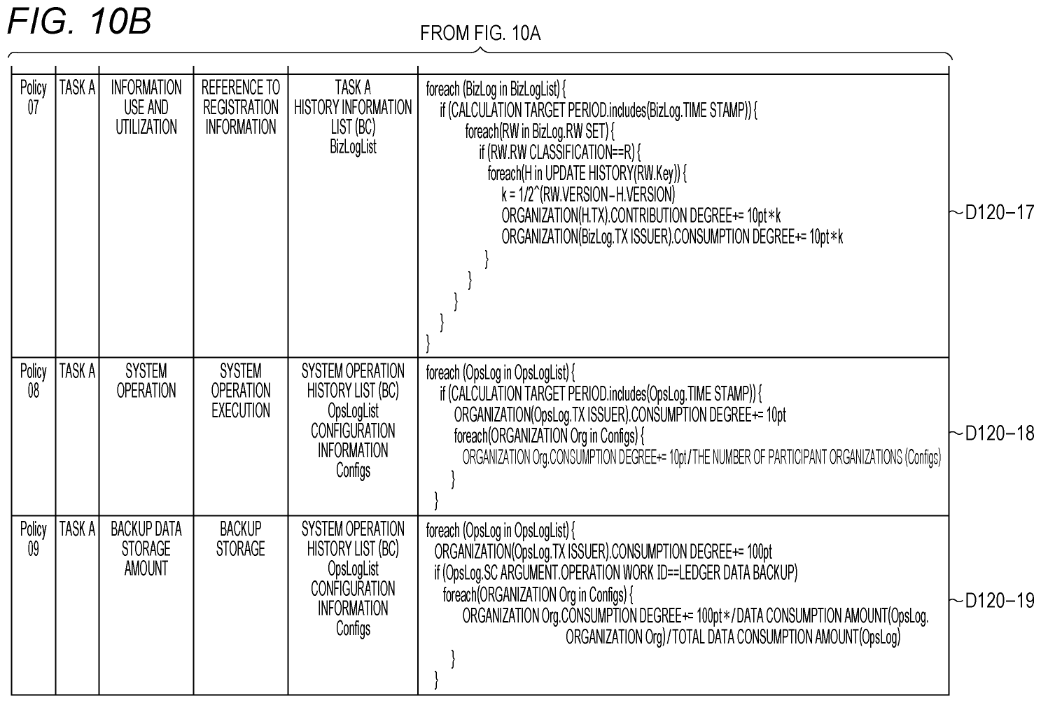

Next, FIGS. 9A and 9B and FIGS. 10A and 10B illustrate an example of a data structure of the system consumption/contribution degree policy D120 managed in the system consumption/contribution degree calculation SC.

In this example, each of the system consumption degree and the system contribution degree is quantified in a unit which is called a point (pt). The system consumption degree and the system contribution degree are separately calculated, points are added up while treating the contribution degree as a point to be added and treating the consumption degree as a point to be subtracted, and a deduction from a point wallet (the same concept as a wallet in a case of a virtual currency) of each organization is performed.

In other words, these “points” can be regarded as a unique token (virtual currency) in this SC. As long as consensus can be built among participant organizations and quantification is possible, any unit may be used without being limited to the unit described above. For example, an actually existing currency unit such as the yen or the dollar may be used.

The data structure illustrated in the drawing is assumed to be in a state where it is managed in an internal table D1104 of the information D1112 in the state information 12. In the present embodiment, a plurality of system consumption/contribution degree calculation policies are defined according to a task channel or an SC as a calculation target, or system consumption/contribution contents thereof.

A column of policy ID_D120-1 is information for identifying a defined system consumption/contribution degree calculation rule.

Further, a column of SC_ID D120-2 is information for identifying an SC as a target. In the present embodiment, designation of an SC also corresponds to specification of a task channel.

In addition, a column of major classification D120-3 and a column of minor classification D120-4 are classification label information indicating system consumption/contribution contents as a calculation target.

Further, a column of achievement information D120-5 as an input is achievement information used as an input of the system consumption/contribution degree calculation of this policy, and is assumed to be capable of being referred to by two or more organizations participating in at least a calculation processing (SC execution).

Further, a column of calculation logic D120-6 shows detailed calculation logic of the system consumption/contribution in this policy. It is assumed that the calculation logic of the present embodiment is described by a programming language used for description of an SC, or a program code according to a domain specific language (DSL).

In the example in the drawing, a pseudo-code simulating a general object-oriented language such as Java (registered trademark) is used. In addition to using control syntax such as for each or if which is the same as the general programming language, arithmetic operation notation including an equivalent/non-equivalent/comparison operator such as “!=” or “==”, and an increment operator such as “+=”, expression of object-oriented class/instance, specifically, and notation such as reference/substitution of a member variable by object.member variable notation or a call of a member function by an object.member variable (argument) are used.

It should be noted that a function used inside the SC may be separately defined as a member function of each class, or may be described in the calculation logic (in the present embodiment, in order to prevent explanation from being lengthy, it is assumed that the function used inside the SC is separately defined).

In addition, in the calculation logic of the present embodiment, calculation of a system contribution degree and calculation of a system consumption degree related to each SC or classification are defined in one policy. However, the respective calculations may be separately defined. In a case of the separate definition, although management is complicated, it is easy to more minutely perform the calculation processing.

It is assumed that these calculation policies (D120-11 to D120-19 in the drawings) are agreed upon by participants of the distributed ledger system 5 in advance and defined (deployed). It should be noted that the calculation policy may be frequently updated under an agreement among the participants.

The calculation processing using these calculation policies will be described in detail in description of a flowchart to be described below.

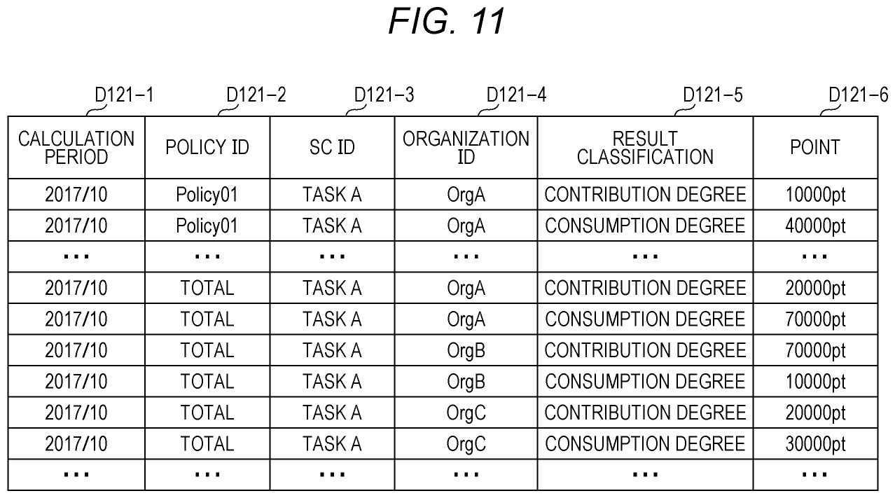

FIG. 11 illustrates an example of a data structure of the system consumption/contribution degree calculation result D122 managed in the system consumption/contribution degree calculation SC.

The data structure illustrated in the drawing is assumed to be in a state where it is managed in the internal table D1104 of the information D1112 in the state information 12.

Columns D121-1 to D121-5 are information for identifying a calculation result. A column of calculation period D122-1 is a calculation period designated in an argument at the time of execution of an SC function “calculation processing” of the system consumption/contribution degree calculation SC. Columns of policy ID_D121-2 and SC_ID_D121-3 are information corresponding to the columns D120-1 and D120-2 of the system consumption/contribution degree policy D120, respectively. Further, a column of organization_ID_D121-4 is information for identifying an organization corresponding to this calculation result. A column of result classification D121-5 is information for identifying whether the calculation result is a “contribution degree” or a “consumption degree”.

Further, in a column of point D121-6, a calculation result (point) corresponding to the columns D121-1 to D121-5 is stored. As a special case of the column of policy ID_D121-2, “total” is registered, rather than a policy ID. In this case, a result of adding up point calculation results of all policies with respect to a corresponding SC name, a calculation period, an organization, and a result classification is shown.

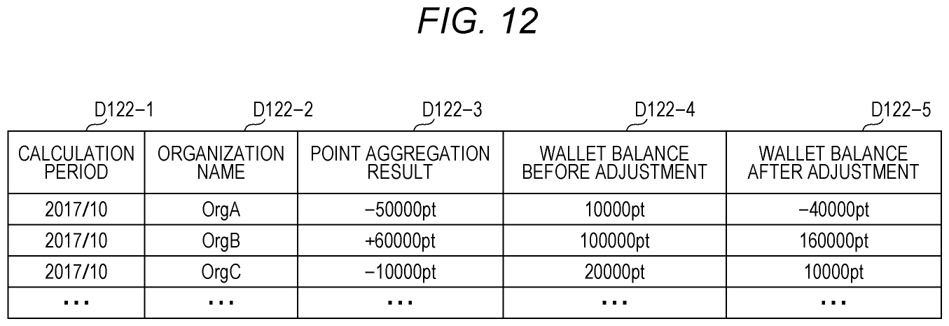

Next, FIG. 12 illustrates an example of a data structure of the point aggregation result D122 managed in the system consumption/contribution degree calculation SC. The data structure illustrated in the drawing is assumed to be in a state where it is managed in the internal table D1104 of the information D1112 in the state information 12.

A column of calculation period D122-1 is a calculation period designated in an argument at the time of execution of the SC function “calculation processing” of the system consumption/contribution degree calculation SC. Further, a column of organization_ID_D122-2 is information for identifying an organization corresponding to this aggregation result. A column of point aggregation result D122-3 is an aggregation result obtained by adding up points while treating the calculated contribution degree as a point to be added, and treating the calculated consumption degree as a point to be subtracted. A column D122-4 is a point balance in a wallet holding/managing points of each organization before adjustment, and a column D122-5 is a point balance after adding the column D122-3 to the column D122-4, that is, after adjustment.

### Processing Flow: Member Registration

Hereinafter, a flow example of a utilization management method according to the first embodiment will be descried. In the first embodiment, an example in which system consumption/contribution degree calculation is performed by using a task transaction history as achievement information is shown as a basic form.

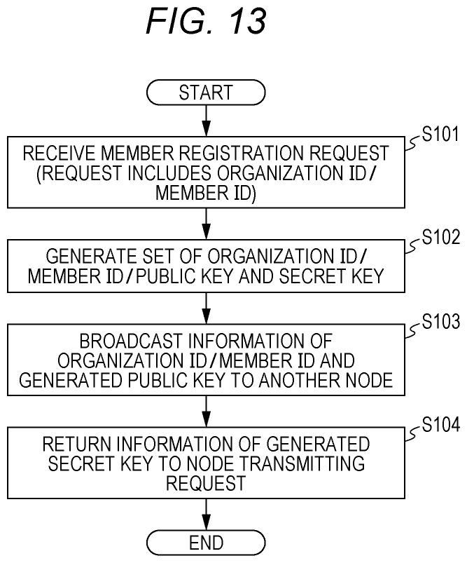

FIG. 13 is a flowchart showing an example of a processing for registration of a new member participating in the distributed ledger system 5.

In this case, the member management unit 33 of the distributed ledger node 3 receives a member registration request from another node such as the client node 4 (S101). Here, the member registration request includes a member ID uniquely identifying a requesting member.

The member management unit generates a set of a secret key D31 and a public key D32 and associates the set of keys with the member ID (S102).

Next, the member management unit 33 broadcasts the member ID as the new registration target and the generated public key D32 to another node (S103). Information of the member ID and the generated public key D32 which are broadcasted is stored in each node as the participant member management information D3.

Further, the member management unit 33 returns the generated secret key D31 to a node requesting the member registration (S104). The node receiving the secret key D31 stores the received secret key D31 as its own secret key D31 in the participant member management information D3.

In the present embodiment, it is assumed that authentication of a member participating in the distributed ledger system 5, signing a TX, a control of SC execution authority, or the like is performed by using the secret key and the public key generated as described above in pairs.

In detail, for example, the client node 4 issues a TX signed by an electronic signature with an issued secret key and a verification node (which is any predetermined node) verifies the electronic signature by using a public key, thereby implementing personal identification.

Since a publicly known or commonly known technology may be applied to a method of generating a set of a public key and a secret key, a method of verifying a signature, and a method of associating keys and an ID, detailed description thereof will not be provided in the first embodiment.

Further, in the present embodiment, the functions of the member management unit 33 are shown in the distributed ledger node 3 as functions. However, a dedicated node for member management may be provided at the outside of the distributed ledger node 3 and the node may provide the equivalent function to that of the member management unit 33.

### Processing Flow: TX Execution Processing

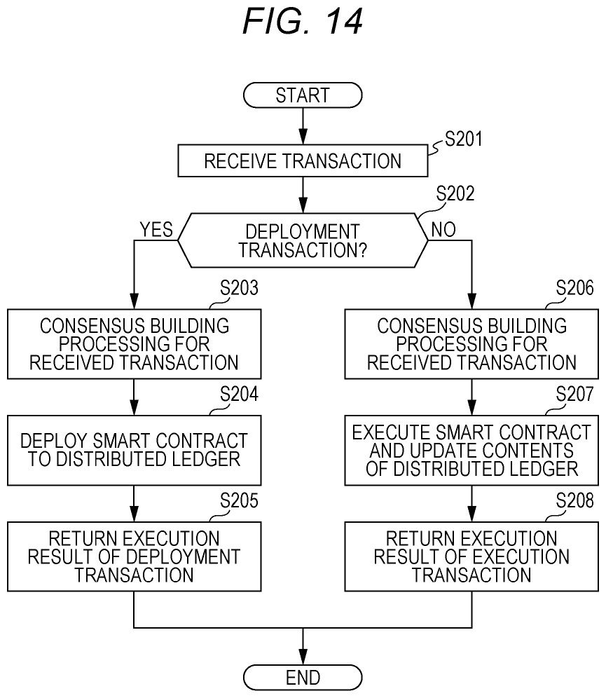

Next, FIG. 14 illustrates a flow example of a TX execution processing, that is, a deployment and execution processing of an SC. The type of SC includes a task, system operation history sharing, system consumption/contribution degree calculation, and the like. In the present embodiment, a difference in a processing depending on the type of SC can be expressed as a different in an SC internal processing, and a flow of a TX execution processing of the SC itself is common.

In this case, the transaction management unit 34 of the distributed ledger node 3 receives a TX from a TX issuing source such as the client node 4 (S201), transfers the TX to the consensus management unit 31 to perform a deployment and execution processing of an SC corresponding to the type of TX.

When the TX received in S201 is a deployment TX of the SC (YES in S202), first, the consensus management unit 31 performs, with another distributed ledger node 3, a consensus building processing on whether to execute the received TX or add the received TX at the end of the BC 11 as a block (S203). As a detailed consensus building processing method, a publicly known or commonly known technology may be applied. For example, adoption of an algorithm which is called Practical Byzantine Fault Tolerance (PBFT), or the like can be considered. The PBFT is an algorithm on condition of consensus by a predetermined number (2/3) or more of nodes among all nodes (that is, verification nodes) participating in consensus building.

In addition, as another example, in the technology disclosed in “Hyperledger Fabric”, [online], [searched on Mar. 31, 2017], Internet <URL: http://hyperledger-fabric.readthedocs.io/en/latest/>), a consensus building algorithm which is called an Endorser-Orderer model is used. In the Endorser-Orderer model, some distributed ledger nodes 3 with approval authority are selected from the distributed ledger nodes 3 and a TX is transmitted, and only the selected distributed ledger nodes perform verification on whether or not the TX is problematic and return an approval when it is verified that the TX is not problematic. When a predetermined consensus building condition (for example, approval by two or more organizations) is satisfied, the TX is accepted. In addition, the approved TX is distributed to all the distributed ledger nodes 3. In the Endorser-Orderer model, it is not necessary that all the distributed ledger nodes 3 perform TX verification, and therefore the Endorser-Orderer model is more efficient in comparison to the PBFT.

Here, a flow after the consensus building based on the Endorser-Orderer model will be simply described. The distributed ledger node 3, first, transmits the received TX to distributed ledger nodes 3 participating in the distributed ledger system 5 and having TX approval authority, each distributed ledger node 3 receiving the TX performs signature verification for the TX to confirm whether or not the signature is falsified or confirm validity of contents of the TX, and returns a confirmation result to the distributed ledger node 3 transmitting the TX. When the predetermined consensus building condition is satisfied, the approval of the TX is completed, and the consensus building is completed with confirmation.

After the consensus building described above, the consensus management unit 31 broadcasts the approved TX to all the distributed ledger nodes 3 by using a function of the approved TX distribution unit 36.

When the approved TX is received, the consensus management unit 31 registers an SC included in the corresponding TX in the distributed ledger D1 through the SC execution/management unit 32 (S204). In detail, SC_ID and an actual state of the SC are registered in the distributed ledger D1 as state information 12 based on contents of the TX, and a block including the deployment TX is added at the end of the BC 11.

Finally, the consensus management unit 31 returns an execution result of the deployment TX to the TX issuing source (S205) and ends the processing.

Meanwhile, when the TX received in S201 is an execution TX of the SC (NO in S202), the distributed ledger nodes 3 perform a consensus building processing, similarly to the case of the deployment TX (S206). The consensus building processing is the same as S203.

When the consensus building is completed, the consensus management unit 31 executes the SC to update contents of the distributed ledger D1 through the SC execution/management unit (S207). In detail, a call function designated in the execution TX and an input argument are assigned to an SC (which is assumed as being already registered) having SC_ID specified in the execution TX to execute the SC. Then, the contents of the distributed ledger D1 are updated based on an execution result. Based on the execution result, state information 12 related to this SC is updated, and the execution TX is added at the end of the BC as a block.

Finally, the consensus management unit 31 returns the execution result (for example, a return value of the function) of the execution TX to the TX issuing source (S209) and ends the processing.

### Processing Flow: System Consumption/Contribution Degree Calculation

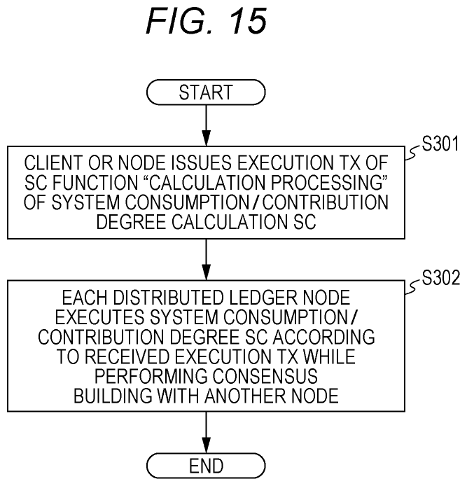

Next, FIG. 15 illustrates a flow of a calculation processing according to the system consumption/contribution degree calculation SC by the entire system according to the first embodiment. In the following description, it is assumed that various SCs which are executed and referred to are already deployed in the distributed ledger.

In this case, it is assumed that an execution TX of an SC function “calculation processing” of the system consumption/contribution degree calculation SC is issued from any node (S301). Then, each distributed ledger node 3 receives the TX, and executes the SC function “calculation processing” of the system consumption/contribution degree calculation SC according to the received execution TX while performing consensus building with another node (S302). Here, the execution TX may be issued when any participant member with SC execution authority performs an operation on a display screen of the management application 42, or may be issued by a direct operation of each node.

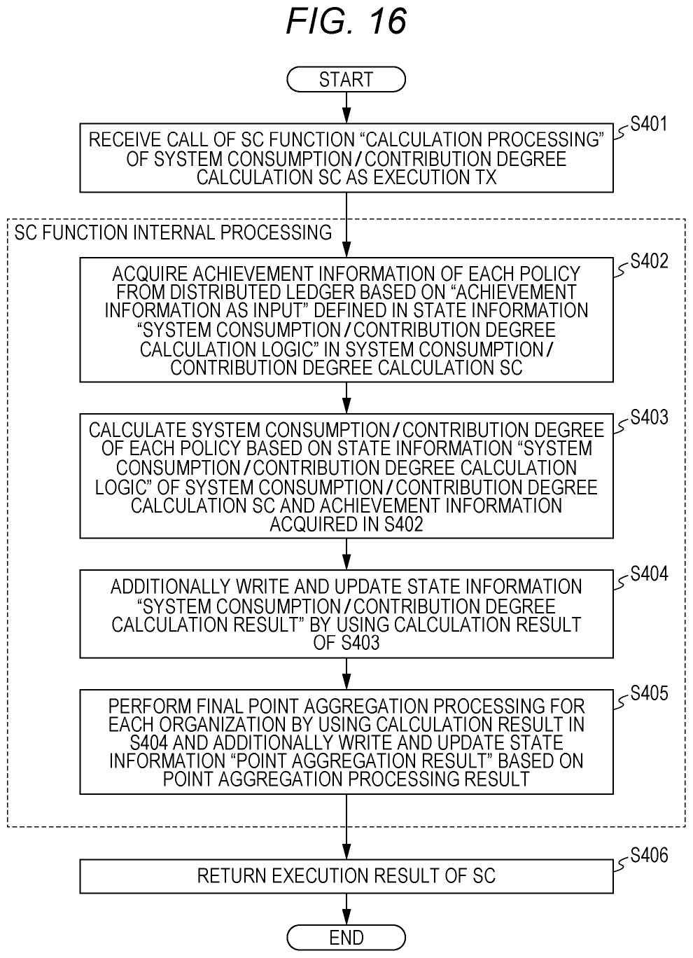

Next, detailed contents of the “calculation processing” will be described. FIG. 16 is a flowchart illustrating an example of an internal processing at the time of calling the SC function “calculation processing” of the system consumption/contribution degree calculation SC.

In this case, each distributed ledger node 3 receives a call of the SC function “calculation processing” of the system consumption/contribution degree calculation SC as an operation execution TX on which consensus is built (S401), and executes a system consumption/contribution degree calculation processing according to this TX by the function of the SC execution/management unit 32. In the present embodiment, a “calculation target period” is input as an argument of the SC function. A detailed internal processing is shown below. The description of the consumption/contribution degree calculation is provided in detail with the “task A” which has been described above as a target.

First, the distributed ledger node 3 refers to state information “system consumption/contribution degree calculation policy” of the system consumption/contribution degree calculation SC, and acquires achievement information which is needed for each rule from the distributed ledger based on “achievement information as an input” defined in the state information (S402).

Detailed examples of the system consumption/contribution degree calculation policy illustrated in FIGS. 9A and 9B and FIGS. 10A and 10B will be described, policy IDs from a “Policy 01” to a “Policy 07” are system consumption/contribution degree calculation policies based on an execution history of the “task A”. In addition, a “Policy 08” and a “Policy 09” are calculation policies based on a system operation history of the “task A”, thus are not used in the present embodiment, but are used in a second embodiment.

Here, the distributed ledger node 3 first acquires a history information list of the “task A” commonly used in the “Policy 01” to “Policy 07” by referring to the column of “achievement information as input” of the used “Policy 01” to “Policy 07”. In the following description, this list will also be referred to as “BizLogList”. The BizLogList is, specifically, a series of history information (in FIG. 4A, the block D1001, in FIG. 5A the block D1005) accumulated in the BC 11 of the task SC_D11 of the distributed ledger D1.

Further, the distributed ledger node 3 acquires configuration information of the distributed ledger system 5 used in the “Policy 04” to “Policy 06”. In the following description, the acquired configuration information will also be referred to as “Configs”. The Configs is, specifically, an aggregation of configuration information in which the channel is the “task A” among the configuration information D2 of FIG. 7. The acquired achievement information such as the BizLogList or the Configs is mapped to an object on a programming language of the SC based on the data structure illustrated in FIG. 4A, 4B or 7 so that an operation (reference or the like) is easily performed in the SC.

Next, the distributed ledger node 3 calculates a system consumption degree and a system contribution degree by each organization according to each policy based on the “calculation logic” defined in the state information “system consumption/contribution degree calculation policy” of the system consumption/contribution degree calculation SC and the achievement information acquired in S402 (S403). Hereinafter, each policy will be described.

### Policy 01: TX Execution Processing Amount

This calculation policy is an example of the system consumption/contribution degree calculation policy related to a TX amount of the “task A”. In this example, a policy in which an organization issuing the TX of the “task A” consumes a resource or data of the distributed ledger system 5 (hereinafter, referred to as system) and an organization providing a node or data for an execution processing of the TX contributes to the system is provided. A detailed calculation processing according to logic described in a column of “calculation logic” in this policy will be described.

The distributed ledger node 3 first acquires a piece of history information of the task A which is not used for calculation from the BizLogList. Hereinafter, the acquired history information will be called BizLog.

Next, the distributed ledger node 3 refers to a time stamp of the BizLog (for example, corresponding to a time stamp in TX information of the block D1005 in FIG. 5A) to determine whether or not the time stamp of the BizLog is within the “calculation target period” designated in an argument of an SC function.

When it is determined that the time stamp of the BizLog is not within the “calculation target period”, the distributed ledger node 3 skips a subsequent processing related to this BizLog. In contrast, when it is determined that the time stamp of the BizLog is within the “calculation target period”, the distributed ledger node 3 confirms whether or not the type of TX (for example, corresponding to the type of TX in the TX information of the block D1005 in FIG. 5A) of this BizLog is the execution or the deployment.

When the type of TX is neither the execution nor the deployment, the distributed ledger node 3 skips a subsequent processing related to this BizLog. In contrast, when the type of TX is the execution or the deployment, the distributed ledger node 3 refers to a TX issuer and a TX executer/approver in the BizLog (for example, corresponding to a TX issuer (including electronic signature information) and a TX executer/approver (including electronic signature information) in the TX information of the block D1005 in FIG. 5A, respectively).

Then, when each acquired TX executer/approver does not coincide with the TX issuer, the distributed ledger node 3 repeats addition of 10 pt of a contribution degree by an organization to which the TX executer/approver belongs and addition of 10 pt of a consumption degree by an organization to which the TX issuer belongs. For example, in a case of a certain BizLog, when a TX issuer is a user of an “organization A”, and a TX executer/approver are respective users of the “organization A”, an “organization B”, and an “organization C”, a consumption degree by the “organization A” is 20 pt, and contribution degrees of the “organization B” and the “organization C” are 10 pt, respectively.

The distributed ledger node 3 calculates a system consumption degree and a system contribution degree by each organization according to this policy by repeating these processings by the number of pieces of acquired history information.

### Policy 02: TX Reference Processing Amount

This calculation policy is an example of the system consumption/contribution degree calculation policy related to a TX amount of the “task A”. In this example, a policy in which an organization issuing the TX of the “task A” consumes the system and an organization providing a node for a reference processing of the TX contributes to the system is provided.

Since costs of the reference processing are generally smaller than that of the TX execution, an amount of added points is smaller than that in the Policy 01 described above. A detailed calculation processing according to logic described in a column of “calculation logic” in this policy will be described.

The distributed ledger node 3 first acquires a piece of history information of the “task A” which is not used for calculation from the BizLogList. Hereinafter, the acquired history information will be called BizLog.

Next, the distributed ledger node 3 refers to a time stamp of the BizLog to determine whether or not the time stamp of the BizLog is within the “calculation target period” designated in an argument of an SC function.

When it is determined that the time stamp of the BizLog is not within the “calculation target period”, the distributed ledger node 3 skips a subsequent processing related to this BizLog. In contrast, when the time stamp of the BizLog is within the “calculation target period”, the distributed ledger node 3 confirms whether or not the type of TX of this BizLog is the reference.

When the type of TX is not the reference, the distributed ledger node 3 skips a subsequent processing related to this BizLog. In contrast, when the type of TX is the reference, the distributed ledger node 3 refers to a TX issuer and a TX executer/approver in the BizLog.

Then, when each acquired TX executer/approver does not coincide with the TX issuer, the distributed ledger node 3 repeats addition of 2 pt of a contribution degree by an organization to which the TX executer/approver belongs and addition of 2 pt of a consumption degree by an organization to which the TX issuer belongs. For example, in a case of a certain BizLog, when a TX issuer is a user of the “organization A”, and a TX executer/approver is a user of the “organization B”, a consumption degree by the “organization A” is 2 pt and a contribution degree by the “organization B” is 2 pt.

The distributed ledger node 3 calculates a system consumption degree and a system contribution degree by each organization according to this policy by repeating these processings by the number of pieces of acquired history information.

### Policy 03: Approved TX Distribution Processing Amount

This calculation policy is an example of the system consumption/contribution degree calculation policy related to a TX amount of the “task A”. In this example, a policy in which an organization issuing the TX of the “task A” consumes the system and an organization providing a node for distribution of the TX to each node of each organization after approval of the TX contributes to the system is provided. A detailed calculation processing according to logic described in a column of “calculation logic” in this policy will be described.

In this case, the distributed ledger node 3 first acquires a piece of history information of the “task A” which is not used for calculation from the BizLogList. Hereinafter, the acquired history information will be called BizLog.

Next, the distributed ledger node 3 refers to a time stamp of the BizLog to determine whether or not the time stamp of the BizLog is within the “calculation target period” designated in an argument of an SC function.

When it is determined that the time stamp of the BizLog is not within the “calculation target period”, the distributed ledger node 3 skips a subsequent processing related to this BizLog. In contrast, when the time stamp of the BizLog is within the “calculation target period”, the distributed ledger node 3 confirms whether or not the type of TX of this BizLog is the execution or the deployment.

When the type of TX is neither the execution nor the deployment, the distributed ledger node 3 skips a subsequent processing related to this BizLog. In contrast, when the type of TX is the execution or the deployment, the distributed ledger node 3 refers to a TX issuer and an approved TX distributor in the BizLog (for example, an approved TX distributor (including electronic signature information) in the TX information of the block D1005 in FIG. 5A).

Then, when the acquired approved TX distributor does not coincide with the TX issuer, the distributed ledger node 3 performs addition of 2 pt of a contribution degree by an organization to which the approved TX distributor belongs and addition of 2 pt of a consumption degree by an organization to which the TX issuer belongs.

The distributed ledger node 3 calculates a system consumption degree and a system contribution degree by each organization according to this policy by repeating these processings by the number of pieces of acquired history information.

### Policy 04: TX Event Notification Processing Amount

This calculation policy is an example of the system consumption/contribution degree calculation policy related to a TX amount of the “task A”. In this example, a policy in which when a TX event is issued, an organization providing a node for distribution of the TX event to each node of each organization contributes to the system and an organization receiving the event consumes the system is provided. A detailed calculation processing according to logic described in a column of “calculation logic” in this policy will be described.

In this case, the distributed ledger node 3 first acquires a piece of history information of the “task A” which is not used for calculation from the BizLogList. Hereinafter, the acquired history information will be called BizLog.

Next, the distributed ledger node 3 refers to a time stamp of the BizLog to determine whether or not the time stamp of the BizLog is within the “calculation target period” designated in an argument of an SC function.

When it is determined that the time stamp of the BizLog is not within the “calculation target period”, the distributed ledger node 3 skips a subsequent processing related to this BizLog. In contrast, when it is determined that the time stamp of the BizLog is within the “calculation target period”, the distributed ledger node 3 confirms whether or not the type of TX of this BizLog is the execution and whether or not the BizLog includes a TX event (for example, a TX event in the TX information of the block D1005 in FIG. 5A).

When it is confirmed that the type of TX of this BizLog is not the execution and the BizLog does not include the TX event, the distributed ledger node 3 skips a subsequent processing related to this BizLog. In contrast, when it is confirmed that the type of TX of this BizLog is the execution and the BizLog includes the TX event, the distributed ledger node 3 acquires a node owner related to the task A from the Configs.

This information can be acquired by extracting an “organization” in which a channel is the “task A” and a “member ID” is a “node” in FIG. 7.

In addition, the distributed ledger node 3 refers to the approved TX distributor in the BizLog. Then, the distributed ledger node 3 performs addition of 0.1 pt of a consumption degree by an organization of each node owner and performs addition of 0.1 pt of a contribution degree by an organization to which the approved TX distributor belongs by the number of node owners.

The distributed ledger node 3 calculates a system consumption degree and a system contribution degree by each organization according to this policy by repeating these processings by the number of pieces of acquired history information.

### Policy 05: SC Registration Task Operation

This calculation policy is an example of the system consumption/contribution degree calculation policy related to task operation. In this example, a policy in which at the time of SC registration/update, an organization to which a TX issuer considered to develop an SC as a target/perform task operation belongs contributes to the system, and an organization receiving the SC and owning a node consumes the system is provided. A detailed calculation processing according to logic described in a column of “calculation logic” in this policy will be described.

In this case, the distributed ledger node 3 first acquires a piece of history information of the “task A” which is not used for calculation from the BizLogList. Hereinafter, the acquired history information will be called BizLog.

Next, the distributed ledger node 3 confirms whether or not the type of TX of the BizLog is the deployment. When it is confirmed that the type of TX is not the deployment, the distributed ledger node 3 skips a subsequent processing related to this BizLog. In contrast, when the type of TX is the deployment, the distributed ledger node 3 acquires a node owner related to the task A from the Configs, similarly to the Policy 04.

In addition, the distributed ledger node 3 refers to the TX issuer in the BizLog. Then, the distributed ledger node 3 performs addition of 10 pt of a consumption degree by an organization of each node owner and performs addition of 10 pt of a contribution degree by an organization to which the TX issuer belongs by the number of node owners.

The distributed ledger node 3 calculates a system consumption degree and a system contribution degree by each organization according to this policy by repeating these processings by the number of pieces of acquired history information.

### Policy 06: Ledger Data Storage Amount

This calculation policy is an example of the system consumption/contribution degree calculation policy related to a data storage amount. In this example, a policy in which an organization issuing an execution TX and accumulating a larger amount of data than a history (BC) of a distributed ledger contributes to an operation of the system is provided. A detailed calculation processing according to logic described in a column of “calculation logic” in this policy will be described.

In this case, the distributed ledger node 3 first acquires a piece of history information of the “task A” which is not used for calculation from the BizLogList. Hereinafter, the acquired history information will be called BizLog.

Next, the distributed ledger node 3 confirms whether or not the type of TX of the BizLog is the execution. When the type of TX is not the execution, the distributed ledger node 3 skips a subsequent processing related to this BizLog. In contrast, when the type of TX is the execution, the distributed ledger node 3 acquires a node owner related to the task A from the Configs, similarly to the Policy 04.

In addition, the distributed ledger node 3 refers to the TX issuer in the BizLog. Then, the distributed ledger node 3 performs addition of 1 pt of a contribution degree by an organization of each node owner and performs addition of 1 pt of a consumption degree by an organization to which the TX issuer belongs by the number of node owners (that is, the number of copies).

The distributed ledger node 3 calculates a system consumption degree and a system contribution degree by each organization according to this policy by repeating these processings by the number of pieces of acquired history information.

### Policy 07: Use and Utilization of Registration Information

This calculation policy is an example of the system consumption/contribution degree calculation policy related to information use and utilization related to the “task A”. Information registered in a distributed ledger by an SC can be regarded as information which is worth being shared by others, when the information is referred to by someone.

In this example, a policy in which when an RW set of each TX is confirmed and referred to, a TX issuer uses information, that is, consumes the system, and an information provider, that is, a TX issuer performing update of the information which is referred to contributes to the system is provided. A detailed calculation processing according to logic described in a column of “calculation logic” in this policy will be described.

The distributed ledger node 3 first acquires a piece of history information of the “task A” which is not used for calculation from the BizLogList. Hereinafter, the acquired history information will be called BizLog.

Next, the distributed ledger node 3 refers to a time stamp of the BizLog to determine whether or not the time stamp of the BizLog is within the “calculation target period” designated in an argument of an SC function.

When it is determined that the time stamp of the BizLog is not within the “calculation target period”, the distributed ledger node 3 skips a subsequent processing related to this BizLog. In contrast, when it is determined that the time stamp of the BizLog is within the “calculation target period”, the distributed ledger node 3 acquires an RW set (for example, corresponding to an RW set in the TX information of the block D1005 in FIG. 5A) of this BizLog.

The distributed ledger node 3 determines whether or not RW classification is “R” with respect to each acquired RW row. When it is determined that the RW classification is “R”, the distributed ledger node 3 performs addition of a contribution degree by each TX issuer which has updated information described in this row in the past.

In detail, based on Key information of a corresponding RW row, update of the Key, that is, all histories (update history) of which the RW classification is “W” are extracted from the BizLogList. Then, addition of a contribution degree by an organization to which a TX issuer of a TX of the update history belongs is performed. The point value halves by 10 pt as an update generation becomes out of date. Addition of a consumption degree by an organization to which a TX issuer (that is, referring to information) of the BizLog belongs as much as the same point as that of the contribution degree is performed.

The distributed ledger node 3 calculates a system consumption degree and a system contribution degree by each organization according to this policy by repeating these processings by the number of pieces of acquired history information.

As described above, after performing system consumption/contribution degree calculation of each policy in S403 in the flow illustrated in FIG. 16, the distributed ledger node 3, by using a result of the calculation, additionally writes/updates state information “system consumption/contribution degree calculation result” of the system consumption/contribution degree calculation SC (S404). In this case, a result of adding up system consumption/contribution degrees of respective organizations for each task is also registered in addition to the system consumption/contribution degree calculation result of each policy.

In addition, the distributed ledger node 3 performs a final point aggregation processing for each organization by using the result in S404 and additionally writes/updates state information “point aggregation result” of the system consumption/contribution degree calculation SC based on a point aggregation processing result (S405).

In the present embodiment, as the point aggregation processing, for example, all the system contribution degrees and all the system consumption degrees of respective organizations in a calculation target period are added up, respectively, and are treated as a point to be added and a point to be subtracted, respectively, thereby aggregating points. This aggregation result may be output and presented as a charging request/remuneration amount for each organization. Alternatively, a wallet for points may be prepared for each organization and point adjustment may also be performed by adding and subtracting points to and from the wallet based on the point aggregation result.

Finally, the distributed ledger node 3 returns an execution result of this SC (S406) and ends the processing.

As described above, according to the present embodiment, calculation logic of a system consumption/contribution degree is executed as an SC on a distributed ledger which can execute common logic while a plurality of organizations build consensus/are synchronized, and history information stored in the distributed ledger is utilized as information with objectivity, rather than a self-reported information with low credibility, thereby implementing mutual calculation/verification by the plurality of organizations. A plurality of nodes have the same copies (distributed ledger), such that it is possible to guarantee credibility by cross-checking. When using the configuration of the present embodiment having the characteristics as described above, it is possible to fairly/impartially calculate a system consumption/contribution degree by each organization in a distributed ledger system configured by bringing resources or the like across a plurality of organizations/administrative domains, and fairly implement cross-organizational system charging or remuneration distribution by utilizing a result of the calculation.

In the present embodiment, although an example in which one transaction is stored in one block is for simplification of description, a plurality of transactions may also be stored in one block. The present invention can also be applied to the case where a plurality of transactions are stored in one block.

In addition, in the present embodiment, a fixed value is used as a point value to be added or subtracted at the time of calculation, but the point value may vary based on a predetermined policy. For example, the point value may be determined based on an actual use amount of resources or data, or a service charge. This case may be realized by recording a result measured by using a monitoring tool, a monitoring agent, or the like together in the distributed ledger.

Further, although the configuration information D2 is described as data managed by the function of the distributed ledger node 3, the configuration information D2 may also be managed on an SC. Such a method may be used as long as a plurality of organizations can confirm the configuration information.

In addition, the calculation logic in the system consumption/contribution degree calculation policy D120 may be defined in an argument as a meta language or a domain specific language (DSL), or may be embedded in an SC function in advance. When the calculation logic is defined as the meta language, an external definition becomes possible, and thus flexibility is improved. Meanwhile, when the calculation logic is embedded in an SC function, there is an advantage that management becomes easy.

### Second Embodiment

Hereinafter, the second embodiment will be descried as another embodiment. However, since the second embodiment is based on the first embodiment, overlapping description will be omitted.

In the second embodiment, an example in which system consumption/contribution degree calculation is performed by using a system operation history as achievement information, in addition to using a task transaction history (execution history) like the first embodiment, is shown. The second embodiment is different from the first embodiment in that the system operation history sharing SC_D13 is used, and the policies “Policy 08” and “Policy 09” in FIGS. 9A and 9B are used. Other processings are basically common between the first embodiment and the second embodiment.

Here, a difference from the first embodiment in regard to the internal processing at the time of calling the SC function “calculation processing” of the system consumption/contribution degree calculation SC illustrated in FIG. 16 will be described.

First, a distributed ledger node 3 acquires achievement information required in each role in S402 from a distributed ledger and acquires a system operation history list of a “task A” required in policy IDs “Policy 08” and “Policy 09” in addition to BizLogList and Configs. In the following description, this list will also be referred to as “OpsLogList”. The OpsLogList is, specifically, a series of history information (in FIG. 4B, the block D1002, in FIG. 5A, the block D1006) accumulated in a BC 11 of a system operation history sharing SC_D13 of a distributed ledger D1.

Next, the distributed ledger node 3 additionally executes each policy related to the following system operation history in the processing of calculating a system consumption degree and a system contribution degree by each organization in S403.

### Policy 08: System Operation Execution

This calculation policy is an example of a system consumption/contribution degree calculation policy related to system operation. In this example, a policy in which an organization issuing an execution TX for a system operation history sharing SC with respect to a system operation work (for example, an operation work to be shared among organizations involved in a node or distributed ledger managed for the “task A”) related to the “task A”, that is, an organization executing an operation work contributes to the system, and another participant organization pays a reward (in other words, consumes the system) is provided. A detailed calculation processing according to logic described in a column of “calculation logic” in this policy will be described.

In this case, the distributed ledger node 3 first acquires a piece of history information related to an operation of the “task A” which is not used for calculation from the OpsLogList. Hereinafter, the acquired history information will be called OpsLog.

Next, the distributed ledger node 3 refers to a time stamp of the OpsLog (for example, corresponding to a time stamp in TX information of the block D1006 in FIG. 5A) to determine whether or not the time stamp of the OpsLog is within a “calculation target period” designated in an argument of an SC function.

When it is determined that the time stamp of the OpsLog is not within the “calculation target period”, the distributed ledger node 3 skips a subsequent processing related to this OpsLog. In contrast, when the time stamp of the OpsLog is within the “calculation target period”, the distributed ledger node 3 acquires a TX issuer (for example, corresponding to a TX issuer (including electronic signature information) in TX information of the block D1006 in FIG. 5A) of this OpsLog.

Then, the distributed ledger node 3 performs addition of 10 pt of a contribution degree by an organization to which the acquired TX issuer belongs.

Next, the distributed ledger node 3 acquires node owners related to the “task A” from the Configs similarly to the Policy 04, and organizations of the node owners equally bear 10 pt, in other words, addition of a consumption degree by the organizations is performed.

The distributed ledger node 3 calculates a system consumption degree and a system contribution degree by each organization according to this policy by repeating these processings by the number of pieces of acquired history information.

### Policy 08: Ledger Backup Data Storage Amount

This calculation policy is an example of the system consumption/contribution degree calculation policy related to a backup data storage amount. In this example, a policy in which an organization issuing an execution TX for a system operation history sharing SC with respect to a backup data storage amount of a ledger related to the “task A”, that is, an organization holding backup data by executing a backup work contributes to the system, and another participant organization pays a reward (in other words, consumes the system) is provided. A detailed calculation processing according to logic described in a column of “calculation logic” in this policy will be described.

In this case, the distributed ledger node 3 first acquires a piece of history information related to an operation of the “task A” which is not used for calculation from the OpsLogList. Hereinafter, the acquired history information will be called OpsLog.

Next, the distributed ledger node 3 refers to an operation work ID included in an SC argument of the OpsLog (for example, corresponding to a first argument of “call function+input argument” in TX information of the block D1006 in FIG. 5A) to determine whether or not the operation work is “ledger data backup”.

When it is determined that the operation work is not the “ledger data backup”, the distributed ledger node 3 skips a subsequent processing related to this OpsLog.

In contrast, when the operation work is the “ledger data backup”, the distributed ledger node 3 acquires a TX issuer of this OpsLog.

Then, the distributed ledger node 3 performs addition of 100 pt of a contribution degree by an organization to which the acquired TX issuer belongs.

Next, the distributed ledger node 3 acquires node owners related to the “task A” from the Configs similarly to the Policy 04, and organizations of the node owners bear 100 pt at a ratio of an amount of ledger data consumption of each organization, in other words, addition of a consumption degree by the organizations is performed. It should be noted that calculation of the amount of data consumption may be performed in the same manner as that of the Policy 06, thus a detailed description thereof will be omitted.

The distributed ledger node 3 calculates a system consumption degree and a system contribution degree by each organization according to this policy by repeating these processings by the number of pieces of acquired history information.

### Third Embodiment

In a third embodiment, an example in which cross-task system consumption/contribution degree calculation is performed when a plurality of tasks are managed in a distributed ledger system 5 is shown.

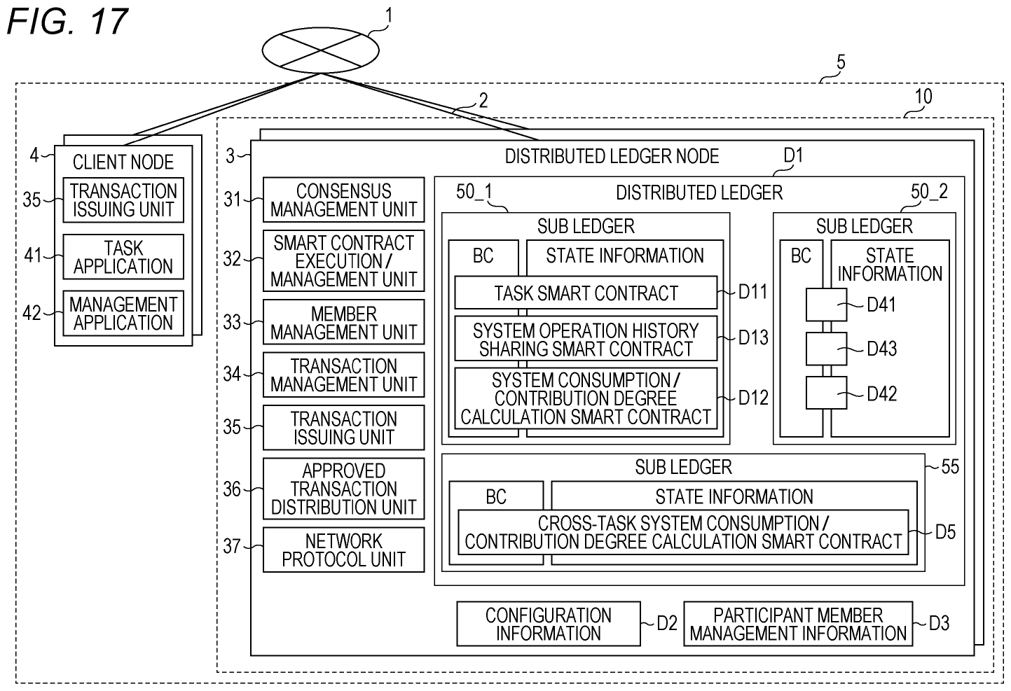

FIG. 17 schematically illustrates a distributed ledger system 5 assumed in the third embodiment. This distributed ledger system 5 is basically the same as those of Embodiments 1 and 2, but is different from those of Embodiments 1 and 2 in that a sub ledger 50 is managed for each task in a distributed ledger D1.

In a sub ledger 50_1 related to a “task A”, a task SC_D11, a system consumption/contribution degree calculation SC_D12, and a system operation history sharing SC_D13 are included as an SC, similarly to the first embodiment. Meanwhile, in a sub ledger 50_2 related to a “task B”, D41 to D43 are included as an SC.

In addition, in a distributed ledger node 3 in the present embodiment includes a cross-task sub ledger 55 in which a cross-task system consumption/contribution degree calculation SC_D5 of the “task A” and the “task B” is managed. Only an organization participating in the respective tasks is given the right of access to the sub ledger 50_1 of the “task A” and the sub ledger 50_2 of the “task B” and can perform sharing/reference/execution on the distributed ledger. For this reason, an organization which does not participate in a task channel cannot refer to the sub ledgers.

Meanwhile, all organizations can access the cross-task system consumption/contribution degree calculation SC_D5 of the present embodiment. An organization participating in both of the “task A” and the “task B” executes a calculation processing by this SC, such that it is possible to secure credibility or fairness by mutual calculation even in a cross-organizational manner.

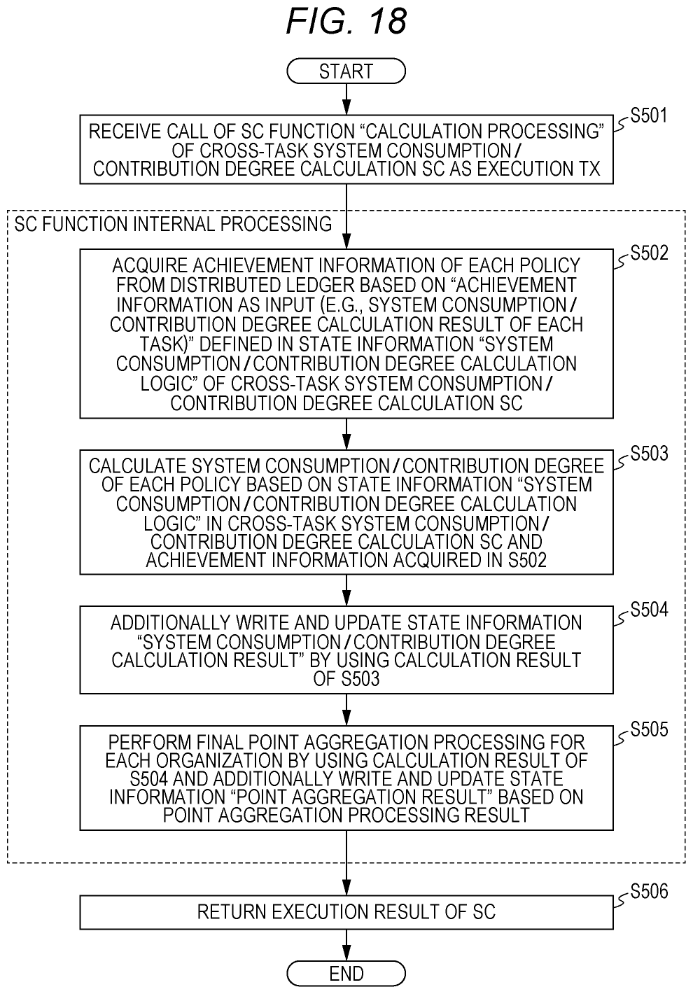

FIG. 18 illustrates a flow example of an internal processing of a cross-task system consumption/contribution degree calculation SC according to the present embodiment. In this flow, a basic processing flow is the same as those of the first embodiment and the second embodiment, except that a cross-task system consumption/contribution degree calculation SC_D4 is used instead of the system consumption/contribution degree calculation SC_D12 of the “task A” (S401 to S406 correspond to S501 to S506, respectively).

As a precondition before executing calculation, system consumption/contribution degree calculation of the “task A” and the “task B” is completed (alternatively, the calculation may be performed by a system consumption/contribution degree calculation SC of each task which is started as a result of execution of the cross-task system consumption/contribution degree calculation SC_D4).

In this case, the distributed ledger node 3 uses, for example, a system consumption/contribution degree calculation result of each task or a point aggregation result in acquisition of achievement information in S502.

In addition, in S503, the distributed ledger node 3 calculates a cross-task system consumption/contribution degree calculation result or a point aggregation result by offsetting, for example, a system consumption/contribution degree by each organization or a point aggregation result among tasks. In detail, for example, when point calculation is performed for a data amount held by an organization performing both of the “task A” and the “task B” in a distributed ledger, calculation for the “task A” and calculation for the “task B” both are basically calculation based on the same target. For the point for the data amount of the distributed ledger of the organization, a processing in which a value calculated for any one of the “task A” and the task “B” is subtracted from an aggregation value of the values calculated for the “task A” and the “task B”, respectively, can be assumed. This can be similarly assumed in a case where a transaction commonly occurs in the “task A” and the “task B”.

As described above, according to the third embodiment, it is possible to secure credibility and fairness by mutual calculation even in a cross-organizational manner.

As described above, according to the present invention, it is possible to calculate a system consumption/contribution degree from various viewpoints such as a TX amount, task operation, a data storage amount, use and utilization of information, system operation, a backup data amount, or the like, as shown in the description of various calculation policies. As a result, management more minutely and strictly reflecting a system consumption/contribution degree situation becomes possible.

It should be noted that the present invention is not limited to a participant performing both of contribution and consumption. That is, there may be an organization only providing a resource or data or only performing system operation, or an organization only performing utilization/consumption.

In the described embodiments of the present invention, a system contribution/consumption degree calculation policy is provided for each SC_ID, but the present invention is not limited thereto. The calculation policy may be a policy provided for each target SC and a function thereof, or a policy which is common for a plurality of SCs, or a combination thereof.

In the described embodiments of the present invention, it is assumed that a reference transaction is registered in a BC every time a TX is issued. However, another means may be used as long as a participant can objectively confirm achievement. For example, execution logs locally held by each organization may be bundled up and registered in the BC as other history information.

In the described embodiments of the present invention, a system consumption/contribution degree is calculated for each organization. However, the system consumption/contribution degree may be calculated for each participant member, not for each organization. When the system consumption/contribution degree is calculated for each participant member, details of the system consumption/contribution can be managed more minutely, and an exchange (in other words, P2P transaction of a virtual currency) of points related to the system consumption/contribution degree can be performed among participant members (that is, man to man) can be performed.

In the described embodiments of the present invention, a contribution degree and a consumption degree are equivalent (the same rate). In addition, in the third embodiment, points of sub ledgers are equivalent, but an exchange rate may be set between the points of the sub ledgers. The exchange rate may be defined in a system consumption/contribution degree calculation SC in advance.

The present invention is most effective in system consumption/contribution degree management in a consortium-type distributed ledger system, but can be applied to all systems operated in a manner in which a plurality of organizations are gathered while bringing a resource or data (for example, grid computing). However, it is assumed that achievement information (for example, operation log) related to utilization of/contribution to a management target system is shared/accumulated in a distributed ledger. In this case, a node executing a distribution processing (task) which is a management target and a distributed ledger node may be separated from each other. For example, when a client and a server output the same operation log, respectively, every time a TX related to the management target system is issued, and achievement information based on the log is accumulated in the distributed ledger, it is possible to improve objectivity of the achievement information to a level of the distributed ledger system.

Hereinabove, the best mode for implementing the present invention has been described in detail. However, the present invention is not limited thereto and can be modified without departing from the gist of the present invention.

According to the present embodiment described above, credibility of an SC is secured with mutual consensus/synchronization among respective organizations forming a consortium in a distributed ledger system, consumption of and contribution to a predetermined management target system including a distributed ledger system are accurately acquired, and fair and impartial charging management based on the information is implemented.

That is, it is possible to accurately understand and utilize a utilization situation and a contribution situation with respect to a system which is commonly utilized by constituent organizations of a consortium-type distributed ledger system.

By the description of the present specification, at least the following is clarified. That is, in the utilization management method of the present embodiment, each of a plurality of nodes may store information of a transaction accepted by performing consensus building among the nodes of the plurality of organizations in a distributed ledger as a processing history by executing a first smart contract, and store a calculation result in the distributed ledger by performing consensus building for calculation with a node of another organization accessible to the processing history in the distributed ledger in the execution of a second smart contract.

By doing so, it is possible to execute all of a processing and storage of a transaction and calculation using them in a situation in which appropriate veracity by performing consensus building among predetermined nodes. Further, it is possible to accurately understand and utilize a utilization situation and a contribution situation with respect to a system which is commonly utilized by constituent organizations of a consortium-type distributed ledger system.

Further, in the utilization management method according to the present embodiment, in the execution of the second smart contract, each of the plurality of nodes may specify a processing history of an organization related to at least any one of the consumption degree and the contribution degree based on configuration information held in a predetermined storage device and indicating an attribute of each of the plurality of organizations, and information of at least one of an issuer of a corresponding transaction, an approver of the corresponding transaction, an executer of the corresponding transaction, a reference target or update target of the corresponding transaction, and a receiver of an issuing event of the corresponding transaction indicated by the processing history, and calculate at least any one of the consumption degree and the contribution degree by the corresponding organization based on information indicated by the specified processing history.

By doing so, it is possible to more efficiently and accurately perform specification and extraction of a processing history of a transaction which should be used for calculation of a consumption degree or a contribution degree from processing histories of the transaction. Further, it is possible to accurately understand and utilize a utilization situation and a contribution situation with respect to a system which is commonly utilized by constituent organizations of a consortium-type distributed ledger system.

Further, in the utilization management method of the present embodiment, in the execution of the second smart contract, each of the plurality of nodes may perform aggregation for at least any one of an amount of transactions, an amount of resource consumption required for execution of a corresponding transaction, a data storage amount, a load of operation of a task or a system, a holding amount of backup data, and achievement of use and utilization of data from the processing history, and calculate at least any one of the consumption degree and the contribution degree based on a result of the aggregation.

By doing so, it is possible to efficiently prepare information required for calculation of a consumption degree or a contribution degree and use the information for the calculation. Further, it is possible to accurately understand and utilize a utilization situation and a contribution situation with respect to a system which is commonly utilized by constituent organizations of a consortium-type distributed ledger system.

Further, in the utilization management method of the present embodiment, each of the plurality of nodes may specify a processing history for each of the plurality of organizations by using signature information of the organizations recorded in the processing history at the time of the specification of the processing history.

By doing so, it is possible to conveniently specify and extract a signature which should be used for calculation as a key from a processing history of a transaction stored in a distributed ledger. Further, it is possible to accurately understand and utilize a utilization situation and a contribution situation with respect to a system which is commonly utilized by constituent organizations of a consortium-type distributed ledger system.

Further, in the utilization management method of the present embodiment, each of the plurality of nodes may convert at least any one of the calculated consumption degree and the calculated contribution degree into a predetermined token exchangeable among organizations, and further execute a predetermined adjustment processing corresponding to a magnitude of a contribution degree or a consumption degree by a corresponding organization through a corresponding token.

In this case, a virtual currency having high affinity with the distributed ledger system, or the like is used as a token, such that it is possible to efficiently collect a charge for use of a system of each organization which is a constituent of a consortium-type distributed ledger system. Further, it is possible to accurately understand and utilize a utilization situation and a contribution situation with respect to a system which is commonly utilized by constituent organizations of a consortium-type distributed ledger system.

Further, in the utilization management method of the present embodiment, each of the plurality of nodes may manage the distributed ledger for each task executed in the management target system, execute calculation of at least one of the consumption degree and the contribution degree by each of the plurality of organizations for each task, and calculate at least any one of a consumption degree and a contribution degree in a cross-task manner by aggregating at least any one of the calculated consumption degree and the calculated contribution degree by each of the plurality of organizations for each task while offsetting an overlap among tasks, with respect to all tasks in the management target system.

By doing so, it is possible to precisely calculate a consumption degree or a contribution degree in a situation in which a certain organization performs a plurality of tasks in the management target system. Further, it is possible to accurately understand and utilize a utilization situation and a contribution situation with respect to a system which is commonly utilized by constituent organizations of a consortium-type distributed ledger system.

Further, in the utilization management method of the present embodiment, each of the plurality of nodes may hold a calculation rule of at least any one of the consumption degree and the contribution degree for each function of the second smart contract and a corresponding smart contract and calculate at least any one of the consumption degree and the contribution degree according to a corresponding calculation rule.

By doing so, for example, it is possible to provide the calculation rule described above for each task or organization and apply the calculation rule to execution of the second smart contract. Further, it is possible to accurately understand and utilize a utilization situation and a contribution situation with respect to a system which is commonly utilized by constituent organizations of a consortium-type distributed ledger system.

Although the present disclosure has been described with reference to example embodiments, those skilled in the art will recognize that various changes and modifications may be made in form and detail without departing from the spirit and scope of the claimed subject matter.

What is claimed is:

1. A utilization management method, wherein in a distributed ledger system constituted by respective nodes of a plurality of organizations, each of at least a plurality of predetermined nodes among the nodes executes a first smart contract which manages a processing history of a transaction in the distributed ledger system in a distributed ledger,
executes a second smart contract which performs, with respect to a management target system commonly used by the plurality of organizations, calculation of at least any one of a consumption degree by each of the plurality of organizations of the management target system and a contribution degree by each of the plurality of organizations to the management target system based on the processing history stored in the distributed ledger, and
stores a result of the calculation in the distributed ledger.

2. The utilization management method according to claim 1, wherein each of the plurality of nodes stores information of a transaction accepted by performing consensus building among the nodes of the plurality of organizations in the distributed ledger as a processing history by executing the first smart contract, and
stores the result of the calculation in the distributed ledger by performing consensus building for the calculation with a node of another organization accessible to the processing history in the distributed ledger, in the execution of the second smart contract.

3. The utilization management method according to claim 2, wherein in the execution of the second smart contract, each of the plurality of nodes specifies a processing history of an organization related to at least any one of the consumption degree and the contribution degree based on configuration information held in a predetermined storage device and indicating an attribute of each of the plurality of organizations, and information of at least one of an issuer of a corresponding transaction, an approver of the corresponding transaction, an executer of the corresponding transaction, a reference target or update target of the corresponding transaction, and a receiver of an issuing event of the corresponding transaction indicated by the processing history, and
calculates at least any one of the consumption degree and the contribution degree by the corresponding organization based on information indicated by the specified processing history.

4. The utilization management method according to claim 3, wherein in the execution of the second smart contract, each of the plurality of nodes performs aggregation for at least any one of an amount of transactions, an amount of resource consumption required for execution of a corresponding transaction, a data storage amount, a load of operation of a task or a system, a holding amount of backup data, and achievement of use and utilization of data from the processing history, and
calculates at least any one of the consumption degree and the contribution degree based on a result of the aggregation.

5. The utilization management method according to claim 3, wherein in the specification of the processing history, each of the plurality of nodes specifies a processing history for each of the plurality of organizations by using signature information of the organizations recorded in the processing history.

6. The utilization management method according to claim 1, wherein each of the plurality of nodes converts at least any one of the calculated consumption degree and the calculated contribution degree into a predetermined token exchangeable among organizations, and
further executes a predetermined adjustment processing corresponding to a magnitude of a contribution degree or a consumption degree by a corresponding organization through a corresponding token.

7. The utilization management method according to claim 1, wherein each of the plurality of nodes manages the distributed ledger for each task executed in the management target system,
executes calculation of at least one of the consumption degree and the contribution degree by each of the plurality of organizations for each task, and
calculates at least any one of a consumption degree and a contribution degree in a cross-task manner by aggregating at least any one of the calculated consumption degree and the calculated contribution degree by each of the plurality of organizations for each task while offsetting an overlap among tasks, with respect to all tasks in the management target system.

8. The utilization management method according to claim 1, wherein each of the plurality of nodes holds a calculation rule of at least any one of the consumption degree and the contribution degree for each function of the second smart contract and a corresponding smart contract, and calculates at least any one of the consumption degree and the contribution degree according to a corresponding calculation rule.

9. A utilization management system, comprising at least a plurality of predetermined nodes among nodes in a distributed ledger system constituted by the respective nodes of a plurality of organizations,
wherein each of the plurality of nodes executes a first smart contract which manages a processing history of a transaction in the distributed ledger system in a distributed ledger,
executes a second smart contract which performs, with respect to a management target system commonly used by the plurality of organizations, calculation of at least any one of a consumption degree by each of the plurality of organizations of the management target system and a contribution degree by each of the plurality of organizations to the management target system based on the processing history stored in the distributed ledger, and
stores a result of the calculation in the distributed ledger.

10. A node, wherein the node is a predetermined node among nodes in a distributed ledger system constituted by the respective nodes of a plurality of organizations,
executes a first smart contract which manages a processing history of a transaction in the distributed ledger system in a distributed ledger,
executes a second smart contract which performs, with respect to a management target system commonly used by the plurality of organizations, calculation of at least any one of a consumption degree by each of the plurality of organizations of the management target system and a contribution degree by each of the plurality of organizations to the management target system based on the processing history stored in the distributed ledger, and
stores a result of the calculation in the distributed ledger.
